(19) United States
(12) Patent Application Publication
(10) Pub. No.: US 2026/0322547 A1
(43) Pub. Date: Oct. 15, 2026

(54) UPLINK WAVEFORM CONFIGURATION METHOD AND APPARATUS, DEVICE, AND STORAGE MEDIUM

(71) Applicant: Beijing Xiaomi Mobile Software Co., Ltd., Beijing (CN)

(72) Inventors: Xueyuan GAO, Beijing (CN); Xiaowei JIANG, Beijing (CN); Xuemei QIAO, Beijing (CN)

(73) Assignee: Beijing Xiaomi Mobile Software Co., Ltd., Beijing (CN)

(21) Appl. No.: 19/114,483

(22) PCT Filed: Sep. 29, 2022
(86) PCT No.: PCT/CN2022/122932

§ 371 Date: Mar. 24, 2025

(51) Int. Cl. H04L 5/00; H04L 27/26; H04W 72/1263

(52) U.S. Cl. CPC H04L 5/0044; H04L 27/261; H04W 72/1263

(57) ABSTRACT

The present disclosure relates to an uplink waveform configuration method and apparatus, a device, and a storage medium. The method comprises: sending first downlink control information (DCI), the first DCI comprising waveform indication information, the waveform indication information being used for indicating an uplink transmission waveform for use by a terminal during physical uplink shared channel (PUSCH) transmission; and sending second DCI, the second DCI using the uplink transmission waveform indicated in the waveform indication information for scheduling. Sending the first DCI to indicate to the terminal an uplink transmission waveform to use for PUSCH transmission allows for second DCI scheduling on the basis of the same uplink transmission waveform, thereby reducing the overhead of the second DCI, and enhancing uplink coverage.

### CROSS-REFERENCE TO RELATED APPLICATIONS

The application is a U.S. National Stage of International Application No. PCT/CN2022/122932 filed on Sep. 29, 2022, the entire content of which is incorporated herein by reference.

### TECHNICAL FIELD

The present disclosure relates to the technical field of communication, and in particular, to a configuration method, apparatus, device for an uplink waveform and a storage medium.

### BACKGROUND

In the research requirements of Release 18 (R18), the uplink coverage has always been one of the bottleneck in the system performance, which will affect the signal quality and user experience. For parties including operators, there is a strong demand for uplink coverage enhancement. Currently, in the New Radio (NR) system, two types of uplink waveforms are supported: Cyclic Prefix Orthogonal Frequency-Division Multiplexing (CP-OFDM) and Discrete Fourier Transform Spread Orthogonal Frequency Division Multiplexing (DFTS-OFDM).

### SUMMARY

The present disclosure provides a configuration method, apparatus, device for an uplink waveform and a storage medium.

According to the first aspect of the embodiments of the present disclosure, a configuration method of an uplink waveform is provided, the method is performed by a network device, and the method includes: sending first downlink control information (DCI), where the first DCI includes waveform indication information, and the waveform indication information is used to indicate an uplink transmission waveform used by the terminal for a physical uplink shared channel (PUSCH) transmission; and sending second DCI, where the second DCI performs scheduling using the uplink transmission waveform indicated by the waveform indication information.

According to the second aspect of the embodiments of the present disclosure, a configuration method of an uplink waveform is provided, and the method is performed by a terminal, and includes: receiving first downlink control information (DCI), where the first DCI includes waveform indication information, and the waveform indication information is used to indicate an uplink transmission waveform used by the terminal for a physical uplink shared channel (PUSCH) transmission; and receiving second DCI, where the second DCI performs scheduling using the uplink transmission waveform indicated by the waveform indication information.

According to the third aspect of the embodiments of the present disclosure, a configuration apparatus of an uplink waveform is provided, and the apparatus is configured in a network device, and includes: a sending module, configured to send first downlink control information (DCI), where the first DCI includes waveform indication information, and the waveform indication information is used to indicate an uplink transmission waveform used by the terminal for a physical uplink shared channel (PUSCH) transmission; the sending module is further configured to send second DCI, where the second DCI performs scheduling using the uplink transmission waveform indicated by the waveform indication information.

According to the fourth aspect of the embodiments of the present disclosure, a configuration apparatus of an uplink waveform is provided, and the apparatus is configured in a terminal, and includes: a receiving module, configured to receive first downlink control information (DCI), where the first DCI includes waveform indication information, and the waveform indication information is used to indicate an uplink transmission waveform used by the terminal for a physical uplink shared channel (PUSCH) transmission; the receiving module is further configured to receive second DCI, where the second DCI performs scheduling using the uplink transmission waveform indicated by the waveform indication information.

According to the fifth aspect of the embodiments of the present disclosure, a network device is provided, which includes: a processor; and a memory for storing instructions executable by the processor; where the processor is configured to execute any one of the methods in the first aspect.

According to the sixth aspect of the embodiments of the present disclosure, a terminal is provided, which includes: a processor; and a memory for storing instructions executable by the processor; where the processor is configured to execute any one of the methods in the second aspect.

According to the seventh aspect of the embodiments of the present disclosure, a non-transitory computer-readable storage medium is provided, when instructions in the storage medium are executed by a processor of a network device, the network device is enabled to execute any one of the methods in the first aspect.

According to the eighth aspect of the embodiments of the present disclosure, a non-transitory computer-readable storage medium is provided, when the instructions in the storage medium are executed by a processor of a terminal, the terminal is enabled to execute any one of the methods in the second aspect.

It should be understood that the above general description and the following detailed description are exemplary and explanatory only and cannot limit the present disclosure.

### BRIEF DESCRIPTION OF THE DRAWINGS

The accompanying drawings herein are incorporated into the specification and constitute a part of the specification, illustrate the embodiments consistent with the present disclosure, and are used to explain the principles of the present disclosure together with the specification.

FIG. 1 is a schematic diagram of a wireless communication system according to an exemplary embodiment.

FIG. 2 is a schematic diagram of PAPR of different waveforms according to an exemplary embodiment.

FIG. 3 is a flowchart of a configuration method of an uplink waveform according to an exemplary embodiment.

FIG. 4 is a schematic diagram of a DCI structure for data scheduling according to an exemplary embodiment.

FIG. 5 is a schematic diagram of a DCI structure without data scheduling according to an exemplary embodiment.

FIG. 6 is a schematic diagram of a GC DCI structure according to an exemplary embodiment.

FIG. 7 is a schematic diagram of another GC DCI structure according to an exemplary embodiment.

FIG. 8 is a schematic diagram of yet another GC DCI structure according to an exemplary embodiment.

FIG. 9 is a flowchart of another configuration method of an uplink waveform according to an exemplary embodiment.

FIG. 10 is a schematic diagram of a configuration apparatus of an uplink waveform according to an exemplary embodiment.

FIG. 11 is a schematic diagram of another configuration apparatus of an uplink waveform according to an exemplary embodiment.

FIG. 12 is a schematic diagram of a configuration device of an uplink waveform according to an exemplary embodiment.

FIG. 13 is a schematic diagram of another configuration device of an uplink waveform according to an exemplary embodiment.

### DETAILED DESCRIPTION

Hereinafter, exemplary embodiments will be described in detail, and examples thereof are shown in the accompanying drawings. When the following description refers to the accompanying drawings, unless otherwise indicated, the same numbers in different drawings represent the same or similar elements. The implementations described in the following exemplary embodiments do not represent all implementations consistent with the present disclosure.

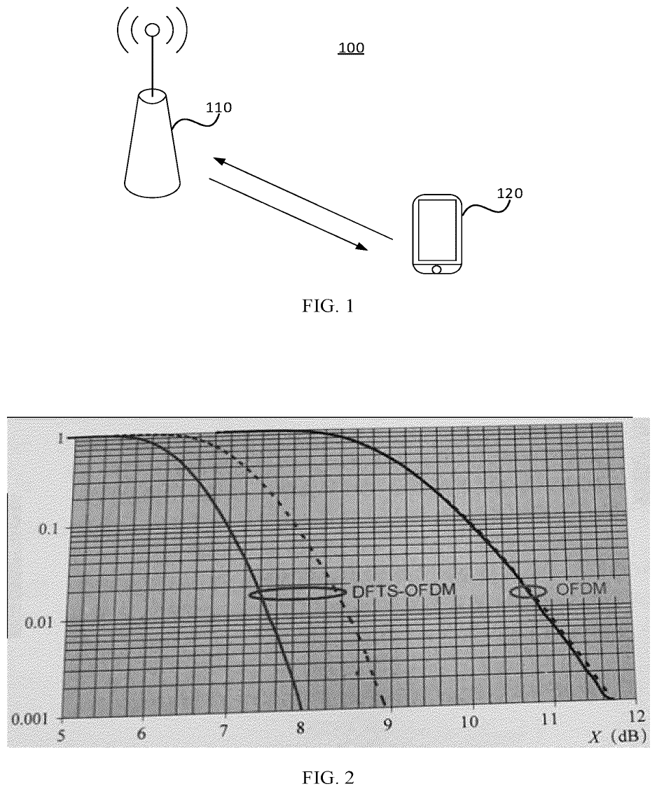

The communication method involved in the present disclosure may be performed by the wireless communication system 100 shown in FIG. 1. The network system may include a network device 110 and a terminal 120. It can be understood that the wireless communication system shown in FIG. 1 is only for illustrative purposes, and the wireless communication system may further include other network devices, such as core network devices, wireless relay devices, and wireless backhaul devices, which are not shown in FIG. 1. The embodiments of the present disclosure do not limit the number of network devices and the number of terminals included in the wireless communication system.

Further, it can be understood that the wireless communication system of the embodiments of the present disclosure is a network that provides wireless communication functions. The wireless communication system may adopt different communication technologies, such as Code Division Multiple Access (CDMA), Wideband Code Division Multiple Access (WCDMA), Time Division Multiple Access (TDMA), Frequency Division Multiple Access (FDMA), Orthogonal Frequency-Division Multiple Access (OFDMA), Single Carrier FDMA (SC-FDMA), and Carrier Sense Multiple Access with Collision Avoidance. According to factors such as the capacity, rate, and delay of different networks, the network may be divided into 2G (2nd Generation) network, 3G network, 4G network, or future evolved network, such as the 5th Generation Wireless Communication System (5G) network, the 5G network may also be referred to as a New Radio (NR) network. For the convenience of description, the wireless communication network is sometimes simply referred to as a network in the present disclosure.

Further, the network device 110 involved in the present disclosure may also be referred to as a radio access network device. The radio access network device includes: a base station, an evolved Node B (eNB), a home base station, an Access Point (AP) in a Wireless Fidelity (WIFI) system, a wireless relay node, a wireless backhaul node, or a Transmission Point (TP), etc., and may also be a gNB in an NR system, or may also be a component or a part of the device that constitutes a base station, etc. When it is a Vehicle-to-Everything (V2X) communication system, the network device may also be a vehicle-mounted device. It should be understood that in the embodiments of the present disclosure, there is no limitation on the specific technology and the specific device form adopted by the network device.

Further, the terminal 120 involved in the present disclosure may also be referred to as a terminal device, a User Equipment (UE), a Mobile Station (MS), a Mobile Terminal (MT), etc., which is a device that provides users with voice and/or data connectivity. For example, the terminal may be a handheld device with a wireless connection function, a vehicle-mounted device, etc. Currently, some examples of the terminal include: a smart phone (Mobile Phone), a Pocket Personal Computer (PPC), a palm computer, a Personal Digital Assistant (PDA), a laptop computer, a tablet computer, a wearable device, or a vehicle-mounted device, etc. In addition, when it is a Vehicle-to-Everything (V2X) communication system, the terminal device may also be a vehicle-mounted device. It should be understood that the embodiments of the present disclosure do not limit the specific technology and the specific device form adopted by the terminal.

In the embodiments of the present disclosure, the network device 110 and the terminal 120 may adopt any feasible wireless communication technology to realize mutual data transmission. The transmission channel corresponding to sending data by the network device 110 to the terminal 120 is referred to as a downlink (DL) channel, and the transmission channel corresponding to sending data by the terminal 120 to the network device 110 is referred to as an uplink (UL) channel. It can be understood that the network device involved in the embodiments of the present disclosure may be a base station. The network device may also be any other possible network device, and the terminal may be any possible terminal, which is not limited in the present disclosure.

In the research requirements of R18, the uplink coverage has always been one of the bottlenecks of the system performance, which will affect the signal quality and user experience, and parties, including operators, have a strong demand for uplink coverage. In NR, two types of uplink waveforms may be supported, such as CP-OFDM and DFTS-OFDM. Currently, semi-static configuration may be made through RRC signaling. The parameter for configuring the physical uplink shared channel (PUSCH) may be as follows:
transformPrecoder ENUMERATED {enabled, disabled} OPTIONAL
it can be expressed that when the configuration parameter is configured to be “enabled”, the DFTS-OFDM waveform is configured; when the configuration parameter is configured to be “disabled”, the CP-OFDM waveform is configured.

However, compared with the CP-OFDM waveform, the DFTS-OFDM waveform has a lower peak to average power ratio (PAPR). Therefore, due to the lower PAPR characteristic, the DFTS-OFDM waveform is more suitable for the scenario where the uplink coverage is limited. For example, also in the frequency range (FR) 2, the uplink coverage problem of users at the cell edge is more prominent.

For example, in a schematic diagram of the PAPRs of different waveforms shown in FIG. 2, it can be seen that the PAPR of the DFTS-OFDM waveform is about 3 decibels (dB) lower than that of the CP-OFDM waveform. The OFDM in the figure refers to the above-mentioned CP-OFDM waveform. The solid line indicates modulation using Quadrature Phase Shift Keying (QPSK), and the dotted line indicates modulation using 16 Quadrature Amplitude Modulation (QAM). When the CP-OFDM waveform in FIG. 2 is modulated using QPSK or 16QAM, the PAPR is almost the same. When the DFTS-OFDM waveform is modulated using QPSK or 16QAM, the difference may be about 0.8 dB. For example, for the cubic metric of different waveforms with different modulation modes, the PAPR of the CP-OFDM waveform is about 3.4 dB, the PAPR of the DFTS-OFDM waveform with QPSK modulation is about 1.0 dB, and the PAPR of the DFTS-OFDM waveform with 16QAM modulation is about 1.8 dB. It can be understood that since the PAPR of the CP-OFDM waveform is almost the same when it is modulated using QPSK or 16QAM, the modulation mode adopted by the CP-OFDM waveform may be not distinguished.

In the related art, the CP-OFDM waveform or the DFTS-OFDM waveform used by the terminal for uplink transmission is semi-statically configured through the Radio Resource Control (RRC) signaling. However, switching between CP-OFDM waveform and DFTS-OFDM waveform requires RRC reconfiguration, which makes the current communication performance relatively low.

Therefore, the present disclosure provides a configuration method of uplink waveform, by sending first downlink control information (DCI) to indicate the uplink transmission waveform used by the terminal for PUSCH transmission, the second DCI may perform scheduling based on the same uplink transmission waveform, thereby reducing the overhead of the second DCI and enhancing the uplink coverage.

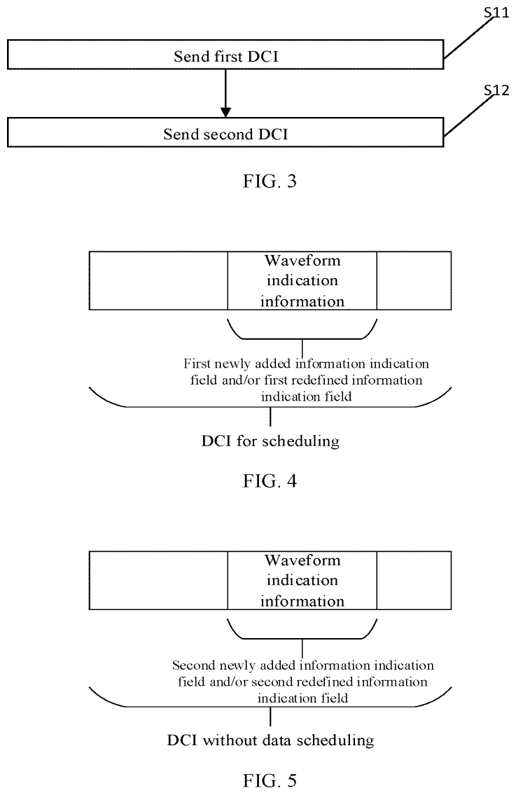

FIG. 3 is a flowchart of a configuration method of uplink waveform according to an exemplary embodiment. As shown in FIG. 3, the method is performed by a network device and may include the following steps:

In step S11, first DCI is sent.

In some embodiments, the network device may send the first DCI. The first DCI includes waveform indication information. The waveform indication information is used to indicate the uplink transmission waveform used by the terminal for PUSCH transmission.

For example, the uplink transmission waveform used by the terminal for PUSCH transmission that is indicated by the waveform indication information may be a CP-OFDM waveform or a DFTS-OFDM waveform.

In step S12, second DCI is sent.

In some embodiments, the network device may send the second DCI. The second DCI performs scheduling using the uplink transmission waveform indicated by the waveform indication information.

For example, the second DCI sent by the network device may include a plurality of information fields or indication fields. The effective payloads corresponding to different information fields or indication fields may be different based on different waveforms. In the second DCI sent by the network device, some information fields or indication fields may perform scheduling using the payload corresponding to the waveform indicated by the waveform indication information. Thus, the overhead of the second DCI can be reduced.

It can be understood that the indication field and the information field in the present disclosure may have the same meaning.

The present disclosure sends the first DCI to indicate the uplink transmission waveform used by the terminal for PUSCH transmission, so that the second DCI performs scheduling based on the same uplink transmission waveform, thereby reducing the overhead of the second DCI and enhancing the uplink coverage.

In the configuration method of uplink waveform provided by the embodiments of the present disclosure, the first DCI may be DCI for data scheduling, and the waveform indication information is carried in a first newly added information indication field and/or a first redefined information indication field in the first DCI.

In some embodiments, the network device sending the first DCI may be the network device sending the DCI for data scheduling. The DCI for data scheduling may include the first newly added information indication field and/or the first redefined information indication field. The first newly added information indication field and/or the first redefined information indication field may be used to carry the waveform indication information. For example, FIG. 4 shows a schematic diagram of a possible DCI structure for data scheduling. The DCI for data scheduling include the first newly added information indication field and/or the first redefined information indication field. The DCI for data scheduling may carry the waveform indication information through the first newly added information indication field and/or the first redefined information indication field.

The present disclosure uses the DCI for data scheduling to carry the waveform indication information to indicate the uplink transmission waveform used by the terminal for PUSCH transmission, so that the second DCI performs scheduling based on the same uplink transmission waveform, thereby reducing the overhead of the second DCI and enhancing the uplink coverage.

In the configuration method of uplink waveform provided by the embodiments of the present disclosure, the first newly added information indication field is a newly added information indication field in the DCI for data scheduling, which is used to indicate the uplink transmission waveform used by the terminal for PUSCH transmission.

In some embodiments, the first newly added information indication field may be a newly added indication field in the DCI for data scheduling. This indication field is used to indicate the uplink transmission waveform used by the terminal for PUSCH transmission. For example, the first newly added information indication field in the DCI for data scheduling indicates that the uplink transmission waveform used by the terminal for PUSCH transmission is CP-OFDM waveform. Alternatively, the first newly added information indication field in the DCI for data scheduling indicates that the uplink transmission waveform used by the terminal for PUSCH transmission is DFTS-OFDM waveform.

For example, assuming that the original DCI for data scheduling includes N indication fields, the DCI for data scheduling involved in the present disclosure may include N+1 indication fields. That is, compared with the original DCI for data scheduling, one first newly added information indication field is newly added in the DCI for data scheduling of the present disclosure. This newly added first newly added information indication field may be used to carry the waveform indication information.

In some embodiments, the first newly added information indication field may be a 1 bit indication field, which is used to indicate the uplink transmission waveform used by the terminal for PUSCH transmission. For example, the first newly added information indication field is 0, which may be used to indicate that the uplink transmission waveform used by the terminal for PUSCH transmission is CP-OFDM waveform. The first newly added information indication field is 1, which may be used to indicate that the uplink transmission waveform used by the terminal for PUSCH transmission is DFTS-OFDM waveform. For another example, the first newly added information indication field is 0, which may be used to indicate that the uplink transmission waveform used by the terminal for PUSCH transmission is DFTS-OFDM waveform. The first newly added information indication field is 1, which may be used to indicate that the uplink transmission waveform used by the terminal for PUSCH transmission is CP-OFDM waveform. It can be understood that the present disclosure does not limit the correspondence between the specific values in the first newly added information indication field and the corresponding waveforms, which may be adjusted arbitrarily according to the actual situation.

In the present disclosure, by adding an information indication field in the DCI for data scheduling to indicate the uplink transmission waveform used by the terminal for PUSCH transmission, the DCI for data scheduling may carry the waveform indication information to indicate the uplink transmission waveform used by the terminal for PUSCH transmission, and then the second DCI may perform scheduling based on the same uplink transmission waveform, thereby reducing the overhead of the second DCI and enhancing the uplink coverage.

In the configuration method of uplink waveform provided by the embodiments of the present disclosure, the first redefined information indication field is used to jointly indicate the uplink transmission waveform used by the terminal for PUSCH transmission; the first redefined information indication field is also used to indicate first other information, there is a predefined explicit or implicit correspondence between the first other information and the uplink transmission waveform, and the first other information is information other than the information indicating the uplink transmission waveform.

In some embodiments, the first redefined information indication field may be an existing indication field in the DCI for data scheduling. This indication field may be used to jointly indicate the uplink transmission waveform used by the terminal for PUSCH transmission. For example, the first redefined information indication field in the DCI for data scheduling indicates that the uplink transmission waveform used by the terminal for PUSCH transmission is CP-OFDM waveform. Alternatively, the first redefined information indication field in the DCI for data scheduling indicates that the uplink transmission waveform used by the terminal for PUSCH transmission is DFTS-OFDM waveform.

In some embodiments, the first redefined information indication field may be an existing indication field in the DCI for data scheduling. For example, the existing indication field may be extended so that the existing indication field may carry the waveform indication information. For example, the existing indication field in the DCI for data scheduling may be extended, and the extended existing indication field may be used as the first redefined information indication field.

For example, the DCI for data scheduling may include an indication field for indicating information A. The indication field of information A may be used to indicate the first other information, such as indicating information A. The indication field of information A may be extended so that different portions of information A may respectively correspond to different waveforms. For example, a portion of information A may correspond to CP-OFDM waveform, and another portion may correspond to DFTS-OFDM waveform.

For example, Table 1 shows a schematic table in which the first redefined information indication field indicates the uplink transmission waveform.

TABLE 1

| First Redefined Information | Uplink Transmission |
|---|---|
| Indication Field | Waveform |
| A1 | CP-OFDM waveform |
| A2 | CP-OFDM waveform |
| A3 | CP-OFDM waveform |
| A4 | DFTS-OFDM waveform |
| A5 | DFTS-OFDM waveform |
| A6 | DFTS-OFDM waveform |

Here, A1, A2 and A3 may be the existing information A in the first redefined information indication field. A relationship between A1, A2 and A3 and a certain waveform, such as CP-OFDM waveform, may be established. Information A may be extended and newly added, such as A4, A5 and A6, and a relationship between A4, A5 and A6 and another waveform, such as DFTS-OFDM waveform, may be established. It can be understood that the extended and newly added information A may be the information A that is pre-reserved but unused.

For example, Table 2 shows another schematic table in which the first redefined information indication field indicates the uplink transmission waveform.

TABLE 2

| First Redefined Information | Uplink Transmission |
|---|---|
| Indication Field | Waveform |
| A1 | CP-OFDM waveform |
| A2 | CP-OFDM waveform |
| A3 | CP-OFDM waveform |
| A4 | DFTS-OFDM waveform |
| A5 | DFTS-OFDM waveform |

Here, A1, A2 and A3 may be the existing information A in the first redefined information indication field. A relationship between A1, A2 and A3 and a certain waveform, such as CP-OFDM waveform, may be established. Information A may be extended and newly added, such as A4 and A5, and a relationship between A4 and A5 and another waveform, such as DFTS-OFDM waveform, may be established. It can be understood that the extended and newly added information A may be the information A that is pre-reserved but unused.

For example, Table 3 shows yet another schematic table in which the first redefined information indication field indicates the uplink transmission waveform.

TABLE 3

| First Redefined Information | Uplink Transmission |
|---|---|
| Indication Field | Waveform |
| A1 | CP-OFDM waveform |
| A2 | CP-OFDM waveform |
| A3 | DFTS-OFDM waveform |
| A4 | DFTS-OFDM waveform |

Here, A1, A2 and A3 may be the existing information A in the first redefined information indication field. A relationship between A1 and A2 and a certain waveform, such as CP-OFDM waveform, may be established. Information A may be extended and newly added, such as A4, and a relationship between A3 and A4 and another waveform, such as DFTS-OFDM waveform, may be established. It can be understood that the extended and newly added information A may be the information A that is pre-reserved but unused.

For example, Table 4 shows still another schematic table in which the first redefined information indication field indicates the uplink transmission waveform.

TABLE 4

| First Redefined Information | Uplink Transmission |
|---|---|
| Indication Field | Waveform |
| A1 | CP-OFDM waveform |
| A2 | CP-OFDM waveform |
| A3 | DFTS-OFDM waveform |
| A4 | DFTS-OFDM waveform |
| A5 | DFTS-OFDM waveform |

Here, A1, A2 and A3 may be the existing information A in the first redefined information indication field. A relationship between A1 and A2 and a certain waveform, such as CP-OFDM waveform, may be established. Information A may be extended and newly added, such as A4 and A5, and a relationship between A3, A4 and A5 and another waveform, such as DFTS-OFDM waveform, may be established. It can be understood that the extended and newly added information A may be the information A that is pre-reserved but unused.

It can be understood that the number of information A corresponding to different waveforms in the first redefined information indication field may be identical or different.

In some embodiments, the uplink transmission waveform used by the terminal for PUSCH transmission indicated in the above Table 1, Table 2, Table 3 and Table 4 may be explicitly indicated or implicitly indicated. For example, explicit indication means that when configuring the first redefined information indication field, i.e., when configuring information A, indication information in which information A corresponds to different waveforms is added. For example, the uplink transmission waveform used by the terminal for PUSCH transmission is directly indicated by the waveform indication information in the first redefined information indication field, for example, a value of 0 in the first redefined information indication field indicates that the waveform indication information indicates that the uplink transmission waveform used by the terminal for PUSCH transmission is CP-OFDM waveform, or a value of 1 in the first redefined information indication field indicates that the waveform indication information indicates that the uplink transmission waveform used by the terminal for PUSCH transmission is DFTS-OFDM waveform. Alternatively, the value in the first redefined information indication field may correspond to the transform precoding, and the uplink transmission waveform used by the terminal for PUSCH transmission is indicated based on whether the transform precoding in the RRC is enabled or disabled.

For another example, the correspondence between information A and the waveform may be preset, and the uplink transmission waveform used by the terminal for PUSCH transmission is indicated by combining the specific information A carried in the first redefined information indication field and the preset correspondence between information A and the waveform. For example, taking Table 1 as an example, the first redefined information indication field may carry information A3. It is preconfigured that the waveform corresponding to information A3 is the CP-OFDM waveform. Then, based on the information A3 carried in the first redefined information indication field, it may be implicitly indicated that the uplink transmission waveform used by the terminal for PUSCH transmission is CP-OFDM waveform.

It can be understood that the above description of the specific values corresponding to the waveforms are merely exemplary description, and the present disclosure is not limited thereto.

In some embodiments, the first redefined information indication field may be an existing indication field in the DCI for data scheduling. For example, in the existing indication field, the corresponding information may have been configured to correspond to different waveforms. Then, such information may be used to jointly indicate the uplink transmission waveform used by the terminal for PUSCH transmission.

For example, the DCI for data scheduling may include an indication field for indicating information B. The indication field of information B may be used to indicate the first other information, such as indicating information B. It is assumed that a relationship between information B and the waveform has been pre-established, that is, different portions of information B may respectively correspond to different waveforms. For example, a portion of information B may correspond to CP-OFDM waveform, and another portion of information B may correspond to DFTS-OFDM waveform.

For example, Table 5 shows another schematic table in which the first redefined information indication field indicates the uplink transmission waveform.

TABLE 5

| First Redefined | |
|---|---|
| Information Indication Field | Uplink Transmission Waveform |
| B1 | CP-OFDM waveform |
| B2 | CP-OFDM waveform |
| B3 | CP-OFDM waveform |
| B4 | DFTS-OFDM waveform |
| B5 | DFTS-OFDM waveform |
| B6 | DFTS-OFDM waveform |

Here, B1, B2, B3, B4, B5 and B6 may be the existing information B in the first redefined information indication field. A relationship between B1, B2 and B3 and a certain waveform, such as CP-OFDM waveform, is pre-established. A relationship between B4, B5 and B6 and another waveform, such as DFTS-OFDM waveform, is pre-established. The uplink transmission waveform used by the terminal for PUSCH transmission may be indicated by the existing information B in the first redefined information indication field and the pre-established relationship between information B and the waveform.

The present disclosure jointly indicates the uplink transmission waveform used by the terminal for PUSCH transmission through the existing indication field in the DCI for data scheduling, so that the DCI for data scheduling may carry the waveform indication information, furthermore, the second DCI may perform scheduling based on the same uplink transmission waveform, thereby reducing the overhead of the second DCI and enhancing the uplink coverage.

In the configuration method of uplink waveform provided by the embodiments of the present disclosure, the first redefined information indication field is the indication field corresponding to the first other information.

In some embodiments, the information corresponding to the first redefined information indication field may be a specific code point, such as 0, 1, 2, 3, 4, etc. This code point may be the code point corresponding to the first other information. Different code point values may correspond to different information in the corresponding indication field. For example, it is assumed the first redefined information indication field corresponds to information A, the code point 0 may correspond to A1, the code point 1 may correspond to A2, and so on. Then, different uplink transmission waveforms used by the terminal for PUSCH transmission may be indicated by corresponding different code point values.

In some embodiments, the information corresponding to the first redefined information indication field may be the first other information, and the first other information is any information other than the waveform. For example, assuming that the first other information is information A, then the first redefined information indication field may directly carry the corresponding information A to correspond to the uplink transmission waveform used by the terminal for PUSCH transmission. For example, the indication is made according to the waveform correspondence shown in the above Table 1, Table 2, Table 3, Table 4 or Table 5.

The present disclosure may indicate the uplink transmission waveform used by the terminal for PUSCH transmission through the indication information contained in the indication field of the first other information or the code point, so that the DCI for data scheduling may carry the waveform indication information, furthermore, the second DCI may perform scheduling based on the same uplink transmission waveform, thereby reducing the overhead of the second DCI and enhancing the uplink coverage.

In the configuration method of uplink waveform provided by the embodiments of the present disclosure, the first other information is the bandwidth part (BWP) indication information or the code point corresponding to the BWP; and/or, the first other information is the demodulation reference signal (DMRS) port indication information or the code point corresponding to the DMRS port.

In some embodiments, the first other information may be the BWP indication information, or may be the code point corresponding to the BWP, so that the DCI for data scheduling may indicate the uplink transmission waveform used by the terminal for PUSCH transmission based on the BWP indication information or the code point corresponding to the BWP.

In some embodiments, the first other information may be the DMRS port indication information, or may be the code point corresponding to the DMRS port, so that the DCI for data scheduling may indicate the uplink transmission waveform used by the terminal for PUSCH transmission based on the DMRS port indication information or the code point corresponding to the DMRS port.

The present disclosure can explicitly or implicitly indicate the uplink transmission waveform used by the terminal for PUSCH transmission through the BWP or the DMRS port, so that the DCI for data scheduling may carry the waveform indication information using the indication field corresponding to the first other information, furthermore, the second DCI may perform scheduling based on the same uplink transmission waveform, thereby reducing the overhead of the second DCI and enhancing the uplink coverage.

In the configuration method of uplink waveform provided by the embodiments of the present disclosure, the first DCI is DCI without data scheduling, and the waveform indication information is carried in a second newly added information indication field and/or a second redefined information indication field in the first DCI.

In some embodiments, the network device sending the first DCI may be the network device sending a DCI without data scheduling. The DCI without data scheduling may include the second newly added information indication field and/or the second redefined information indication field. The second newly added information indication field and/or the second redefined information indication field may be used to carry the waveform indication information.

In some embodiments, the DCI without data scheduling is a DCI for semi-persistent scheduling (SPS) release and a DCI for beam indication. For example, in R17, the DCI without data scheduling may include DCI 1_1 and DCI 1_2.

For example, FIG. 5 shows a schematic diagram of the possible DCI structure without data scheduling. The DCI without data scheduling includes the second newly added information indication field and/or the second redefined information indication field. The DCI without data scheduling may carry the waveform indication information through the second newly added information indication field and/or the second redefined information indication field.

In the related art, in R17, a DCI method for beam indication was introduced, and a DCI without data scheduling was used to indicate the beam information. In order to improve the reliability of the DCI beam indication, a hybrid automatic repeat request-ack (HARQ-ACK) feedback mechanism was also considered for the DCI design. When using the DCI 1_1/1_2 with downlink scheduling information for beam indication, the ACK/NACK feedback information on whether the beam indication information is successfully decoded may be carried in the ACK/NACK feedback of the scheduled physical downlink shared channel (PDSCH).

When using the DCI format 1_1/1_2 without downlink scheduling information for beam indication, in order to simplify the design of the feedback mechanism, the ACK/NACK feedback mechanism when the SPS PDSCH is released is reused. When indicating the beam, the cyclic redundancy check (CRC) of the DCI 1_1/1_2 without scheduling information also needs to be scrambled with the configured scheduling radio network temporary identifier (CS-RNTI). In addition, in order to distinguish whether the DCI is used for beam indication or SPS PDSCH release, the information field of the DCI for SPS release can be set with a special value for beam indication.

For example, Table 6 shows a configuration table of the indication field in the beam indication DCI.

TABLE 6

| Information | |
|---|---|
| Indication Field | Value |
| | DCI format 1_1/1_2 without downlink allocation |
| Redundancy | All 1 |
| Version (RV) | |
| Modulation and | All 1 |
| Coding Scheme | |
| (MCS) | |
| NDI | 0 |
| Frequency | For FDRA Type0, set to all 0; or for FDRA |
| Domain Resource | Type1 in the case of dynamicSwitch, set to all 1 |
| Allocation | |

Here, NDI is the New Data Indicator. It can be understood that the specific configuration in Table 6 may refer to the related art, and the present disclosure will not elaborate on it.

The present disclosure indicates the uplink transmission waveform used by the terminal for PUSCH transmission through the DCI without data scheduling to carry the waveform indication information, so that the second DCI performs scheduling based on the same uplink transmission waveform, thereby reducing the overhead of the second DCI and enhancing the uplink coverage.

In the configuration method of uplink waveform provided by the embodiments of the present disclosure, the second newly added information indication field is an information indication field newly added in the DCI without data scheduling, which is used to indicate the uplink transmission waveform used by the terminal for PUSCH transmission.

In some embodiments, the second newly added information indication field may be a newly added indication field in the DCI for data scheduling. This indication field is used to indicate the uplink transmission waveform used by the terminal for PUSCH transmission. For example, the second newly added information indication field in the DCI for data scheduling indicates that the uplink transmission waveform used by the terminal for PUSCH transmission is CP-OFDM waveform. Alternatively, the second newly added information indication field in the DCI for data scheduling indicates that the uplink transmission waveform used by the terminal for PUSCH transmission is DFTS-OFDM waveform.

For example, assuming that the original DCI without data scheduling includes N indication fields, the DCI without data scheduling involved in the present disclosure may include N+1 indication fields. That is, compared with the original DCI without data scheduling, the DCI without data scheduling of the present disclosure is newly added with one second newly added information indication field. This newly added second newly added information indication field may be used to carry the waveform indication information.

In some embodiments, the second newly added information indication field may be a 1 bit indication field, which is used to indicate the uplink transmission waveform used by the terminal for PUSCH transmission. For example, the second newly added information indication field is 0, which may be used to indicate that the uplink transmission waveform used by the terminal for PUSCH transmission is CP-OFDM waveform. The second newly added information indication field is 1, which may be used to indicate that the uplink transmission waveform used by the terminal for PUSCH transmission is DFTS-OFDM waveform. For another example, the second newly added information indication field is 0, which may be used to indicate that the uplink transmission waveform used by the terminal for PUSCH transmission is DFTS-OFDM waveform. The second newly added information indication field is 1, which may be used to indicate that the uplink transmission waveform used by the terminal for PUSCH transmission is CP-OFDM waveform. It can be understood that the present disclosure does not limit the correspondence between the specific values in the second newly added information indication field and the corresponding waveforms. The specific association can be adjusted arbitrarily according to the actual situation.

In the present disclosure, an information indication field for indicating the uplink transmission waveform used by the terminal for PUSCH transmission is added in the DCI for data scheduling, so that the DCI for data scheduling may carry the waveform indication information to indicate the uplink transmission waveform used by the terminal for PUSCH transmission, furthermore, the second DCI may perform scheduling based on the same uplink transmission waveform, thereby reducing the overhead of the second DCI and enhancing the uplink coverage.

In the configuration method of uplink waveform provided by the embodiments of the present disclosure, the second redefined information indication field is used to jointly indicate the uplink transmission waveform used by the terminal for PUSCH transmission; the second redefined information indication field is also used to indicate second other information, there is a predefined explicit or implicit correspondence between the second other information and the uplink transmission waveform, and the second other information is information other than the information indicating the uplink transmission waveform.

In some embodiments, the second redefined information indication field may be an existing indication field in the DCI without data scheduling. This indication field may be used to jointly indicate the uplink transmission waveform used by the terminal for PUSCH transmission. For example, the second redefined information indication field in the DCI without data scheduling indicates that the uplink transmission waveform used by the terminal for PUSCH transmission is CP-OFDM waveform. Alternatively, the second redefined information indication field in the DCI without data scheduling indicates that the uplink transmission waveform used by the terminal for PUSCH transmission is DFTS-OFDM waveform.

In some embodiments, the second redefined information indication field may be an existing indication field in the DCI for data scheduling. For example, the existing indication field may be extended so that the existing indication field may carry the waveform indication information. For example, the existing indication field in the DCI without data scheduling may be extended, and the extended existing indication field may be used as the second redefined information indication field.

It can be understood that extending the second redefined information indication field may be using the existing indication field that is undefined or unused.

For example, the DCI without data scheduling may include an indication field for indicating information C. The indication field of information C may be used to indicate the second other information, such as indicating information C. The indication field of information C may be extended so that different portions of information C may respectively correspond to different waveforms. For example, a portion of information C may correspond to CP-OFDM waveform, and another portion of information C may correspond to DFTS-OFDM waveform.

For example, Table 7 shows a schematic table in which the second redefined information indication field indicates the uplink transmission waveform.

TABLE 7

| Second Redefined | |
|---|---|
| Information Indication Field | Uplink Transmission Waveform |
| C1 | CP-OFDM waveform |
| C2 | CP-OFDM waveform |
| C3 | CP-OFDM waveform |
| C4 | DFTS-OFDM waveform |
| C5 | DFTS-OFDM waveform |
| C6 | DFTS-OFDM waveform |

Here, C1, C2 and C3 may be the existing information C in the second redefined information indication field. A relationship between C1, C2 and C3 and a certain waveform, such as CP-OFDM waveform, may be established. Information C may be extended and newly added, such as C4, C5 and C6, and a relationship between C4, C5 and C6 and another waveform, such as DFTS-OFDM waveform, may be established. It can be understood that the extended and newly added information C may be the information C that is pre-reserved but unused or the undefined information C.

For example, Table 8 shows another schematic table in which the second redefined information indication field indicates the uplink transmission waveform.

TABLE 8

| Second Redefined | |
|---|---|
| Information Indication Field | Uplink Transmission Waveform |
| C1 | CP-OFDM waveform |
| C2 | CP-OFDM waveform |
| C3 | CP-OFDM waveform |
| C4 | DFTS-OFDM waveform |
| C5 | DFTS-OFDM waveform |

Here, C1, C2 and C3 may be the existing information C in the second redefined information indication field. A relationship between C1, C2 and C3 and a certain waveform, such as CP-OFDM waveform, may be established. Information C may be extended and newly added, such as C4 and C5, and a relationship between C4 and C5 and another waveform, such as DFTS-OFDM waveform, may be established. It can be understood that the extended and newly added information C may be the information C that is pre-reserved but unused or the undefined information C.

For example, Table 9 shows yet another schematic table in which the second redefined information indication field indicates the uplink transmission waveform.

TABLE 9

| Second redefined | |
|---|---|
| information Indication Field | Uplink Transmission Waveform |
| C1 | CP-OFDM waveform |
| C2 | CP-OFDM waveform |
| C3 | DFTS-OFDM waveform |
| C4 | DFTS-OFDM waveform |

Here, C1, C2 and C3 may be the existing information C in the second redefined information indication field. A relationship between C1 and C2 and a certain waveform, such as CP-OFDM waveform, may be established. Information C may be extended and newly added, such as C4, and a relationship between C3 and C4 and another waveform, such as DFTS-OFDM waveform, may be established. It can be understood that the extended and newly added information C may be the information C that is pre-reserved but unused or the undefined information C.

For example, Table 10 shows still another schematic table in which the second redefined information indication field indicates the uplink transmission waveform.

TABLE 10

| Second redefined | |
|---|---|
| information Indication Field | Uplink Transmission Waveform |
| C1 | CP-OFDM waveform |
| C2 | CP-OFDM waveform |
| C3 | DFTS-OFDM waveform |
| C4 | DFTS-OFDM waveform |
| C5 | DFTS-OFDM waveform |

Here, C1, C2 and C3 may be the existing information C in the second redefined information indication field. A relationship between C1 and C2 and a certain waveform, such as CP-OFDM waveform, may be established. Information C may be extended and newly added, such as C4 and C5, and a relationship between C3, C4 and C5 and another waveform, such as DFTS-OFDM waveform, may be established. It can be understood that the extended and newly added information C may be the information C that is pre-reserved but unused or the undefined information C.

It can be understood that the number of information C corresponding to different waveforms in the second redefined information indication field may be identical or different.

In some embodiments, the uplink transmission waveform used by the terminal for PUSCH transmission indicated in the above Table 7, Table 8, Table 9 and Table 10 can be explicitly indicated or implicitly indicated. For example, explicit indication means that when configuring the second redefined information indication field, i.e., when configuring information C, indication information in which information C corresponds to different waveforms is added. For example, the uplink transmission waveform used by the terminal for PUSCH transmission is directly indicated by the waveform indication information in the second redefined information indication field, for example, a value of 0 in the second redefined information indication field indicates that the waveform indication information indicates that the uplink transmission waveform used by the terminal for PUSCH transmission is CP-OFDM waveform, or a value of 1 in the second redefined information indication field indicates that the waveform indication information indicates that the uplink transmission waveform used by the terminal for PUSCH transmission is DFTS-OFDM waveform. Alternatively, the value in the second redefined information indication field may correspond to the transform precoding, and the uplink transmission waveform used by the terminal for PUSCH transmission is indicated based on whether the transform precoding in the RRC is enabled or disabled.

For another example, the correspondence between information C and the waveform may be preset, and the uplink transmission waveform used by the terminal for PUSCH transmission is indicated by combining the specific information C carried in the second redefined information indication field and the preset correspondence between information C and the waveform. For example, taking Table 7 as an example, the second redefined information indication field may carry information C3. It is preconfigured that the waveform corresponding to information C3 is the CP-OFDM waveform. Then, based on the information C3 carried in the second redefined information indication field, it can be implicitly indicated that the uplink transmission waveform used by the terminal for PUSCH transmission is CP-OFDM waveform.

It can be understood that the above description of the specific values corresponding to the waveforms are merely exemplary description, and the present disclosure is not limited thereto.

In some embodiments, the second redefined information indication field may be an existing indication field in the DCI without data scheduling. For example, in the existing indication field, the corresponding information may have been configured to correspond to different waveforms. Then, such information may be used to jointly indicate the uplink transmission waveform used by the terminal for PUSCH transmission.

It can be understood that such second redefined information indication field may be the indication field that has been defined or used.

For example, the DCI without data scheduling may include an indication field for indicating information D. The indication field of information D may be used to indicate the first other information, such as indicating information D. It is assumed that a relationship between information D and the waveform has been pre-established, that is, different portions of information D may respectively correspond to different waveforms. For example, a portion of information D may correspond to CP-OFDM waveform, and another portion may correspond to DFTS-OFDM waveform.

For example, Table 11 shows another schematic table in which the second redefined information indication field indicates the uplink transmission waveform.

TABLE 11

| Second Redefined | |
|---|---|
| Information Indication Field | Uplink Transmission Waveform |
| D1 | CP-OFDM waveform |
| D2 | CP-OFDM waveform |
| D3 | CP-OFDM waveform |
| D4 | DFTS-OFDM waveform |
| D5 | DFTS-OFDM waveform |
| D6 | DFTS-OFDM waveform |

Here, D1, D2, D3, D4, D5 and D6 may be the existing information D in the second redefined information indication field. A relationship between D1, D2 and D3 and a certain waveform, such as CP-OFDM waveform, is pre-established. A relationship between D4, D5 and D6 and another waveform, such as DFTS-OFDM waveform, is pre-established. The uplink transmission waveform used by the terminal for PUSCH transmission may be indicated by the existing information D in the second redefined information indication field and the pre-established relationship between information D and the waveform.

The present disclosure jointly indicates the uplink transmission waveform used by the terminal for PUSCH transmission through the existing indication field in the DCI for data scheduling, so that the DCI for data scheduling may carry the waveform indication information, furthermore, the second DCI may perform scheduling based on the same uplink transmission waveform, thereby reducing the overhead of the second DCI and enhancing the uplink coverage.

In the configuration method of uplink waveform provided by the embodiments of the present disclosure, the second redefined information indication field is the indication field corresponding to the second other information.

In some embodiments, the information corresponding to the second redefined information indication field may be a certain code point, such as 0, 1, 2, 3, 4, etc. This code point may be the code point corresponding to the second other information. Different code point values may correspond to different information in the corresponding indication field. For example, it is assumed that the second redefined information indication field corresponds to information C, the code point 0 may correspond to C1, the code point 1 may correspond to C2, and so on. Then, different uplink transmission waveforms used by the terminal for PUSCH transmission may be indicated by corresponding different code point values.

In some embodiments, the information corresponding to the second redefined information indication field may be the second other information, and the second other information is any information other than the waveform. For example, assuming that the second other information is information C, then the second redefined information indication field may directly carry the corresponding information C to correspond to the uplink transmission waveform used by the terminal for PUSCH transmission. For example, the indication is made according to the waveform correspondence shown in the above Table 7, Table 8, Table 9, Table 10 or Table 11.

The present disclosure can indicate the uplink transmission waveform used by the terminal for PUSCH transmission through the indication information contained in the indication field of the second other information or the code point, so that the DCI for data scheduling may carry the waveform indication information, furthermore, the second DCI may perform scheduling based on the same uplink transmission waveform, thereby reducing the overhead of the second DCI and enhancing the uplink coverage.

In the configuration method of uplink waveform provided by the embodiments of the present disclosure, the second other information is the DMRS sequence initialization information (sequence initialization) or the code point corresponding to the DMRS sequence initialization information; and/or, the second other information is the time domain resource allocation (TDRA) indication information or the code point corresponding to the TDRA.

In some embodiments, the second other information may be the DMRS sequence initialization information or the code point corresponding to the DMRS sequence initialization information, and the indication field corresponding to the second other information may be the DMRS sequence initialization. For example, the indication field of DMRS sequence initialization uses 1 bit to carry the waveform indication information to indicate the uplink transmission waveform used by the terminal for PUSCH transmission.

In some embodiments, the second other information may be the TDRA indication information or the code point corresponding to the TDRA. For example, the TDRA may be preconfigured with a correspondence with the waveform, and then based on the TDRA indication information or the code point corresponding to the TDRA, the uplink transmission waveform used by the terminal for PUSCH transmission is indicated.

The present disclosure can explicitly or implicitly indicate the uplink transmission waveform used by the terminal for PUSCH transmission through the DMRS sequence initialization information or TDRA, enabling the DCI for data scheduling to utilize the indication field corresponding to the second other information to carry the waveform indication information, furthermore, the second DCI may perform scheduling based on the same uplink transmission waveform, thereby reducing the overhead of the second DCI and enhancing the uplink coverage.

In the configuration method of the uplink waveform provided by the embodiments of the present disclosure, the first DCI is a group (group common, GC) DCI, and the waveform indication information is carried in the GC DCI.

In some embodiments, the network device sending the first DCI may be the network device sending the GC DCI. The waveform indication information may be carried in the GC DCI sent by the network device.

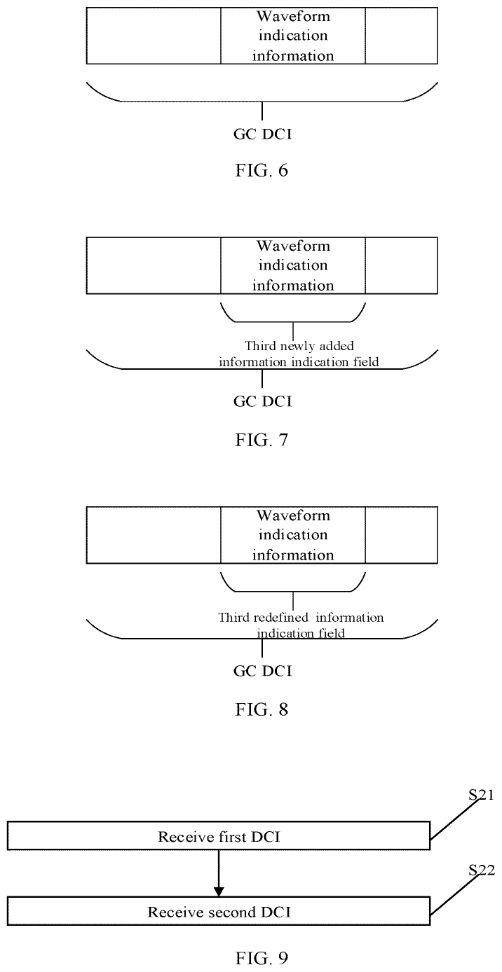

For example, FIG. 6 shows a schematic structural diagram of a possible GC DCI. The GC DCI includes an indication field carrying the waveform indication information.

The present disclosure uses the GC DCI to carry the waveform indication information to indicate the uplink transmission waveform used by the terminal for PUSCH transmission, to enable the second DCI to perform scheduling based on the same uplink transmission waveform, thereby reducing the overhead of the second DCI and enhancing the uplink coverage.

In the configuration method of the uplink waveform provided by the embodiments of the present disclosure, the GC DCI is the group control indication information used to carry the uplink transmission waveform used by the terminal for PUSCH transmission.

In some embodiments, the GC DCI sent by the network device may be a GC DCI dedicated to carrying the uplink transmission waveform used by the terminal for PUSCH transmission. It can be understood that such GC DCI is a new GC DCI different from the existing GC DCI. In the related art, the existing GC DCI is mainly used to indicate the downlink control information of a plurality of different terminals within a specific group. However, the existing GC DCI does not contain the waveform indication information used to indicate the uplink transmission waveform used by the terminal for PUSCH transmission. Therefore, a GC DCI that may be used to indicate the uplink transmission waveforms used by a plurality of different terminals within a specific group for PUSCH transmission may be constructed. Compared with the existing GC DCI, such GC DCI may indicate the uplink transmission waveforms used by a plurality of different terminals within a specific group for PUSCH transmission.

The present disclosure constructs a GC DCI for carrying the uplink transmission waveform used by the terminal for PUSCH transmission, the second DCI may perform scheduling based on the same uplink transmission waveform, thereby reducing the overhead of the second DCI and enhancing the uplink coverage.

In the configuration method of the uplink waveform provided by the embodiments of the present disclosure, the GC DCI includes a third newly added information indication field newly added to indicate the uplink transmission waveform used by the terminal for PUSCH transmission; the GC DCI is also used to jointly indicate or respectively indicate the corresponding waveform indication information for a plurality of terminals within a specific group.

In some embodiments, the GC DCI sent by the network device may include a third newly added information indication field newly added to indicate the uplink transmission waveform used by the terminal for PUSCH transmission. The GC DCI may be used to jointly indicate or respectively indicate the corresponding waveform indication information for a plurality of terminals within a specific group. For example, the GC DCI may be an existing GC DCI. The existing GC DCI may contain the newly added third newly added information indication field, so that the existing GC DCI containing the third newly added information indication field may indicate the uplink transmission waveform used by the terminal for PUSCH transmission.

In some embodiments, the third newly added information indication field may be a newly added indication field in the GC DCI. This indication field is used to indicate the uplink transmission waveform used by the terminal for PUSCH transmission. For example, the third newly added information indication field in the GC DCI indicates that the uplink transmission waveform used by the terminal for PUSCH transmission is CP-OFDM waveform. Alternatively, the first newly added information indication field in the GC DCI indicates that the uplink transmission waveform used by the terminal for PUSCH transmission is DFTS-OFDM waveform.

For example, assuming that the original GC DCI includes M indication fields, the GC DCI involved in the present disclosure may include M+1 indication fields. For example, FIG. 7 shows another schematic structural diagram of the GC DCI. Compared with the original GC DCI, the GC DCI of the present disclosure is newly added with a third newly added information indication field. This newly added third newly added information indication field may be used to carry the waveform indication information.

In some embodiments, the third newly added information indication field may be a 1 bit indication field, which is used to indicate the uplink transmission waveform used by the terminal for PUSCH transmission. For example, the third newly added information indication field is 0, which may be used to indicate that the uplink transmission waveform used by the terminal for PUSCH transmission is CP-OFDM waveform. The third newly added information indication field is 1, which may be used to indicate that the uplink transmission waveform used by the terminal for PUSCH transmission is DFTS-OFDM waveform. For another example, the third newly added information indication field is 0, which may be used to indicate that the uplink transmission waveform used by the terminal for PUSCH transmission is DFTS-OFDM waveform. The third newly added information indication field is 1, which may be used to indicate that the uplink transmission waveform used by the terminal for PUSCH transmission is CP-OFDM waveform. It can be understood that the present disclosure does not limit the correspondence between the specific values in the third newly added information indication field and the corresponding waveforms. The specific association can be adjusted arbitrarily according to the actual situation.

In some embodiments, for example, the GC DCI may be DCI2-3, and a 1 bit third newly added information indication field may be newly added in DCI2-3 to independently indicate the uplink transmission waveform used by the terminal for PUSCH transmission.

The present disclosure adds an information indication field in the GC DCI to indicate the uplink transmission waveform used by the terminal for PUSCH transmission, enabling the GC DCI to carry the waveform indication information to indicate the uplink transmission waveform used by the terminal for PUSCH transmission, furthermore, the second DCI may perform scheduling based on the same uplink transmission waveform, thereby reducing the overhead of the second DCI and enhancing the uplink coverage.

In the configuration method of the uplink waveform provided by the embodiments of the present disclosure, the GC DCI includes a third redefined information indication field used to jointly indicate the uplink transmission waveform used by the terminal for PUSCH transmission; the third redefined information indication field is also used to indicate the third other information, there is a predefined explicit or implicit correspondence between the third other information and the uplink transmission waveform, and the third other information is information other than the information indicating the uplink transmission waveform.

In some embodiments, the GC DCI sent by the network device may include a third redefined information indication field used to jointly indicate the uplink transmission waveform used by the terminal for PUSCH transmission. The GC DCI may also be used to indicate the third other information. For example, the GC DCI may be an existing GC DCI. The existing GC DCI should contain the third redefined information indication field, so that the existing GC DCI containing the third redefined information indication field can indicate the uplink transmission waveform used by the terminal for PUSCH transmission. For example, FIG. 8 shows another schematic structural diagram of the GC DCI. It can be seen that the GC DCI includes a third redefined information indication field, and the third redefined information indication field carries the waveform indication information to indicate the uplink transmission waveform used by the terminal for PUSCH transmission.

In some embodiments, the third redefined information indication field may be an existing indication field in the GC DCI. This indication field may be used to jointly indicate the uplink transmission waveform used by the terminal for PUSCH transmission. For example, the third redefined information indication field in the GC DCI indicates that the uplink transmission waveform used by the terminal for PUSCH transmission is CP-OFDM waveform. Alternatively, the third redefined information indication field in the GC DCI indicates that the uplink transmission waveform used by the terminal for PUSCH transmission is DFTS-OFDM waveform.

In some embodiments, the third redefined information indication field may be an existing indication field in the GC DCI. For example, the existing indication field may be extended so that the existing indication field may carry the waveform indication information. For example, the existing indication field in the GC DCI may be extended, and the extended existing indication field may be used as the third redefined information indication field.

For example, the GC DCI may include an indication field for indicating information E. The indication field of information E may be used to indicate the third other information, such as indicating information E. The indication field of information E may be extended so that different portions of information E may respectively correspond to different waveforms. For example, a portion of information E may correspond to CP-OFDM waveform, and another portion of information E may correspond to DFTS-OFDM waveform.

For example, Table 12 shows a schematic table in which the third redefined information indication field indicates the uplink transmission waveform.

TABLE 12

| Third Redefined | |
|---|---|
| Information Indication Field | Uplink Transmission Waveform |
| E1 | CP-OFDM waveform |
| E2 | CP-OFDM waveform |
| E3 | CP-OFDM waveform |
| E4 | DFTS-OFDM waveform |
| E5 | DFTS-OFDM waveform |
| E6 | DFTS-OFDM waveform |

Here, E1, E2 and E3 may be the existing information E in the third redefined information indication field. A relationship between E1, E2 and E3 and a certain waveform, such as CP-OFDM waveform, may be established. Information E may be extended and newly added, such as E4, E5 and E6, and a relationship between E4, E5 and E6 and another waveform, such as DFTS-OFDM waveform may be extended and newly added. It can be understood that the extended and newly added information E may be the information E that is pre-reserved but unused.

For example, Table 13 shows another schematic table in which the third redefined information indication field indicates the uplink transmission waveform.

TABLE 13

| Third redefined | |
|---|---|
| information Indication Field | Uplink Transmission Waveform |
| E1 | CP-OFDM waveform |
| E2 | CP-OFDM waveform |
| E3 | CP-OFDM waveform |
| E4 | DFTS-OFDM waveform |
| E5 | DFTS-OFDM waveform |

Here, E1, E2 and E3 may be the existing information E in the third redefined information indication field. A relationship between E1, E2 and E3 and a certain waveform, such as CP-OFDM waveform, may be established. Information E may be extended and newly added, such as E4 and E5, and a relationship between E4 and E5 and another waveform, such as DFTS-OFDM waveform, may be established. It can be understood that the extended and newly added information E may be the information E that is pre-reserved but unused.

For example, Table 14 shows yet another schematic table in which the third redefined information indication field indicates the uplink transmission waveform.

TABLE 14

| Third Redefined | |
|---|---|
| Information Indication Field | Uplink Transmission Waveform |
| E1 | CP-OFDM waveform |
| E2 | CP-OFDM waveform |
| E3 | DFTS-OFDM waveform |
| E4 | DFTS-OFDM waveform |

Here, E1, E2 and E3 may be the existing information E in the third redefined information indication field. A relationship between E1 and E2 and a certain waveform, such as CP-OFDM waveform, may be established. Information E may be extended and newly added, such as E4, and a relationship between E3 and E4 and another waveform, such as DFTS-OFDM waveform, may be established. It can be understood that the extended and newly added information E may be the information E that is pre-reserved but unused.

For example, Table 15 shows still another schematic table in which the third redefined information indication field indicates the uplink transmission waveform.

TABLE 15

| Third Redefined | |
|---|---|
| Information Indication Field | Uplink Transmission Waveform |
| E1 | CP-OFDM waveform |
| E2 | CP-OFDM waveform |
| E3 | DFTS-OFDM waveform |
| E4 | DFTS-OFDM waveform |
| E5 | DFTS-OFDM waveform |

Here, E1, E2 and E3 may be the existing information E in the third redefined information indication field. A relationship between E1 and E2 and a certain waveform, such as CP-OFDM waveform, may be established. Information E may be extended and newly added, such as E4 and E5, and a relationship between E3, E4 and E5 and another waveform, such as DFTS-OFDM waveform, may be established. It can be understood that the extended and newly added information E may be the information E that is pre-reserved but unused.

It can be understood that the number of information E corresponding to different waveforms in the third redefined information indication field may be identical or different.

In some embodiments, the uplink transmission waveform used by the terminal for PUSCH transmission indicated in the above Table 12, Table 13, Table 14 and Table 15 can be explicitly indicated or implicitly indicated. For example, explicit indication means that when configuring the third redefined information indication field, that is, when configuring information E, indication information in which information E corresponds to different waveforms is added. For example, the uplink transmission waveform used by the terminal for PUSCH transmission is directly indicated by the waveform indication information in the third redefined information indication field, for example, a value of 0 in the third redefined information indication field indicates that the waveform indication information indicates that the uplink transmission waveform used by the terminal for PUSCH transmission is CP-OFDM waveform, or a value of 1 in the third redefined information indication field indicates that the waveform indication information indicates that the uplink transmission waveform used by the terminal for PUSCH transmission is DFTS-OFDM waveform. Alternatively, the value in the third redefined information indication field may correspond to the transform precoding, and the uplink transmission waveform used by the terminal for PUSCH transmission is indicated based on whether the transform precoding in the RRC is enabled or disabled.

For another example, the correspondence between information E and the waveform may be preset, and the uplink transmission waveform used by the terminal for PUSCH transmission is indicated by combining the specific information E carried in the third redefined information indication field and the preset correspondence between information E and the waveform. For example, taking Table 6 as an example, the third redefined information indication field may carry information E3. It is preconfigured that the waveform corresponding to information E3 is the CP-OFDM waveform. Then, based on the information E3 carried in the third redefined information indication field, it can be implicitly indicated that the uplink transmission waveform used by the terminal for PUSCH transmission is CP-OFDM waveform.

It can be understood that the above description of the specific values corresponding to the waveforms are merely exemplary description, and the present disclosure is not limited thereto.

In some embodiments, the third redefined information indication field may be an existing indication field in the GC DCI. For example, in the existing indication field, the corresponding information may have been configured to correspond to different waveforms. Then, such information may be used to jointly indicate the uplink transmission waveform used by the terminal for PUSCH transmission.

For example, the GC DCI may include an indication field for indicating information F. The indication field of information F may be used to indicate the third other information, such as indicating information F. It is assumed that a relationship between information F and the waveform has been pre-established, that is, different portions of information F may respectively correspond to different waveforms. For example, a portion of information F may correspond to CP-OFDM waveform, and another portion may correspond to DFTS-OFDM waveform.

For example, Table 16 shows another schematic table in which the third redefined information indication field indicates the uplink transmission waveform.

TABLE 16

| Third Redefined | |
|---|---|
| Information Indication Field | Uplink Transmission Waveform |
| F1 | CP-OFDM waveform |
| F2 | CP-OFDM waveform |
| F3 | CP-OFDM waveform |
| F4 | DFTS-OFDM waveform |
| F5 | DFTS-OFDM waveform |
| F6 | DFTS-OFDM waveform |

Here, F1, F2, F3, F4, F5 and F6 may be the existing information F in the third redefined information indication field. A relationship between F1, F2 and F3 and a certain waveform, such as CP-OFDM waveform, is pre-established. A relationship between F4, F5 and F6 and another waveform, such as DFTS-OFDM waveform, is pre-established. The uplink transmission waveform used by the terminal for PUSCH transmission may be indicated by the existing information F in the third redefined information indication field and the pre-established relationship between information F and the waveform.

In some embodiments, the information corresponding to the third redefined information indication field may be a certain code point, such as 0, 1, 2, 3, 4, etc. Different code point values may correspond to different information in the corresponding indication field. For example, It is assumed that the third redefined information indication field corresponds to information E, code point 0 may correspond to E1, code point 1 may correspond to E2, and so on. Then, different code point values may correspond to different uplink transmission waveforms used by the terminal for PUSCH transmission.

In some embodiments, the information corresponding to the third redefined information indication field may be the third other information, where the third other information is any information other than the waveform. For example, assuming that the third other information is information E, the third redefined information indication field may directly carry the corresponding information E to correspond to the uplink transmission waveform used by the terminal for PUSCH transmission. For example, the indication can be made through the waveform correspondence shown in Table 12, Table 13, Table 14, Table 15, or Table 16 above.

The present disclosure jointly indicates the uplink transmission waveform used by the terminal for PUSCH transmission through the existing indication field in the GC DCI, enabling the GC DCI to carry the waveform indication information, furthermore, the second DCI may perform scheduling based on the same uplink transmission waveform, thereby reducing the overhead of the second DCI and enhancing the uplink coverage.

In the configuration method of the uplink waveform provided by the embodiments of the present disclosure, the PUSCH includes at least one of the following: PUSCH of configured grant type 1; PUSCH of configured grant type 2; dynamic grant (DG) PUSCH.

In some embodiments, the PUSCH may be a PUSCH of configured grant (CG) type 1, such as CG PUSCH Type 1.

CG PUSCH represents a grant-free PUSCH, and Type 1 is a scheduling-free scheme of CG PUSCH. In CG PUSCH Type 1, the RRC provides the uplink grant, including the activation of the grant. Once the terminal correctly receives the RRC configuration, it takes effect immediately. The terminal configures all transmission parameters through RRC signaling, including the period, time offset, frequency resources, and the modulation and coding scheme used for uplink transmission. After the terminal receives the RRC configuration, at the time given by the period and offset, the terminal starts to use the configured grant for transmission. The offset is used to control the time when the terminal is permitted to transmit.

In some embodiments, the PUSCH may be a PUSCH of configured grant type 2, such as CG PUSCH Type 2.

In CG PUSCH Type 2, the RRC provides the transmission period, and the base station realizes resource activation and the configuration of some transmission parameters through DCI, thus realizing the activated transmission of this grant configuration. After the terminal receives the activation command, if there is data to be sent in the buffer, it may be transmitted according to the preconfigured period; if there is no data, the terminal will not transmit any data. The sending time of the PDCCH defines the activation time. The terminal confirms the activation/deactivation of the configured grant type 2 by sending a media access control (MAC) control signaling in the uplink.

It can be understood that the difference between CG PUSCH Type 1 and CG PUSCH Type 2 lies in the; activation manner.

In some embodiments, the PUSCH may be a dynamic grant (DG) PUSCH.

The present disclosure can be applied in different types of PUSCH scenarios, in the case of different PUSCH configurations, the first DCI is sent to indicate the uplink transmission waveform used by the terminal for PUSCH transmission, so that the second DCI may perform scheduling based on the same uplink transmission waveform, thereby reducing the overhead of the second DCI and enhancing the uplink coverage.

In the configuration method of the uplink waveform provided by the embodiments of the present disclosure, the first DCI includes DCI 0_1, DCI 0_2, DCI 1_1, and/or downlink DCI 1_2.

In some embodiments, DCI 0_1, DCI 0_2, DCI 1_1, and/or downlink DCI 1_2.

In some embodiments, the uplink DCI may be indicated only when it is DCI 0_1 and/or DCI 0_2.

The present disclosure can be applied in scenarios involving different types of DCI. In scenarios involving different types of DCI, the first DCI is sent to indicate the uplink transmission waveform used by the terminal for PUSCH transmission, so that the second DCI may perform scheduling based on the same uplink transmission waveform, thereby reducing the overhead of the second DCI and enhancing the uplink coverage.

It can be understood that the difference between the DCI for data scheduling and the DCI without data scheduling involved in the present disclosure lies in whether the DCI is used for data scheduling. The difference between the GC DCI and the DCI for data scheduling and the DCI without data scheduling is that the GC DCI may be used to jointly indicate downlink control information for a plurality of terminals within a specific group, or the downlink control information of different terminals may be respectively indicated based on one GC DCI. Their structures may be similar or different.

Based on the same concept, FIG. 9 is a flowchart of another configuration method of the uplink waveform according to an exemplary embodiment. As shown in FIG. 9, the method is performed by the terminal and may include the following steps.

In step S21, first DCI is received.

In some embodiments, the terminal may receive the first DCI. The first DCI includes waveform indication information. The waveform indication information is used to indicate the uplink transmission waveform used by the terminal for PUSCH transmission.

For example, the uplink transmission waveform used by the terminal for PUSCH transmission indicated by the waveform indication information may be CP-OFDM waveform or DETS-OFDM waveform.

In step S22, second DCI is received.

In some embodiments, the terminal may receive the second DCI. The second DCI performs scheduling using the uplink transmission waveform indicated by the waveform indication information.

For example, the second DCI received by the terminal may include a plurality of information fields or indication fields. The payloads corresponding to different information fields or indication fields may be different based on different waveforms. In the second DCI received by the terminal, some information fields or indication fields may perform scheduling using the payload corresponding to the waveform indicated by the waveform indication information, thereby reducing the overhead of the second DCI.

In the present disclosure, the first DCI is received to indicate the uplink transmission waveform used by the terminal for PUSCH transmission, so that the second DCI may perform scheduling based on the same uplink transmission waveform, thereby reducing the overhead of the second DCI and enhancing the uplink coverage.

In the configuration method of the uplink waveform provided by the embodiments of the present disclosure, the first DCI may be DCI for data scheduling, and the waveform indication information is carried in the first newly added information indication field and/or the first redefined information indication field in the first DCI.

In some embodiments, the terminal receiving the sent first DCI may be the terminal receiving the DCI for data scheduling. The DCI for data scheduling may include a first newly added information indication field and/or a first redefined information indication field. The first newly added information indication field and/or the first redefined information indication field may be used to carry the waveform indication information.

For example, as shown in FIG. 4, the DCI for data scheduling includes a first newly added information indication field and/or a first redefined information indication field. The DCI for data scheduling may carry the waveform indication information through the first newly added information indication field and/or the first redefined information indication field.

In the present disclosure, the DCI for data scheduling is used to carry the waveform indication information to indicate the uplink transmission waveform used by the terminal for PUSCH transmission, so that the second DCI may perform scheduling based on the same uplink transmission waveform, thereby reducing the overhead of the second DCI and enhancing the uplink coverage.

In the configuration method of the uplink waveform provided by the embodiments of the present disclosure, the first newly added information indication field is an information indication field newly added in the DCI for data scheduling and used to indicate the uplink transmission waveform used by the terminal for PUSCH transmission.

In some embodiments, the first newly added information indication field may be an indication field newly added in the DCI for data scheduling. This indication field is used to indicate the uplink transmission waveform used by the terminal for PUSCH transmission. For example, the first newly added information indication field in the DCI for data scheduling indicates that the uplink transmission waveform used by the terminal for PUSCH transmission is CP-OFDM waveform. Alternatively, the first newly added information indication field in the DCI for data scheduling indicates that the uplink transmission waveform used by the terminal for PUSCH transmission is DFTS-OFDM waveform.

For example, assuming that the original DCI for data scheduling includes N indication fields, the DCI for data scheduling involved in the present disclosure may include N+1 indication fields. That is, compared with the original DCI for data scheduling, the DCI for data scheduling of the present disclosure is newly added with one first newly added information indication field. The newly added first newly added information indication field may be used to carry the waveform indication information.

In some embodiments, the first newly added information indication field may be a 1 bit indication field, which is used to indicate the uplink transmission waveform used by the terminal for PUSCH transmission. For example, the first newly added information indication field is 0, which may be used to indicate that the uplink transmission waveform used by the terminal for PUSCH transmission is CP-OFDM waveform. The first newly added information indication field is 1, which may be used to indicate that the uplink transmission waveform used by the terminal for PUSCH transmission is DFTS-OFDM waveform. For another example, the first newly added information indication field is 0, which may be used to indicate that the uplink transmission waveform used by the terminal for PUSCH transmission is DFTS-OFDM waveform. The first newly added information indication field is 1, which may be used to indicate that the uplink transmission waveform used by the terminal for PUSCH transmission is CP-OFDM waveform. It can be understood that the present disclosure does not limit the correspondence between the specific values in the first newly added information indication field and the corresponding waveforms, which can be adjusted arbitrarily according to the actual situation.

The present disclosure newly adds an information indication field in the DCI for data scheduling to indicate the uplink transmission waveform used by the terminal for PUSCH transmission, enabling the DCI for data scheduling to carry the waveform indication information to indicate the uplink transmission waveform used by the terminal for PUSCH transmission, furthermore, the second DCI may perform scheduling based on the same uplink transmission waveform, thereby reducing the overhead of the second DCI and enhancing the uplink coverage.

In the configuration method of the uplink waveform provided by the embodiments of the present disclosure, the first redefined information indication field is used to jointly indicate the uplink transmission waveform used by the terminal for PUSCH transmission; the first redefined information indication field is also used to indicate the first other information, there is a predefined explicit or implicit correspondence between the first other information and the uplink transmission waveform, and the first other information is information other than the information indicating the uplink transmission waveform.

In some embodiments, the first redefined information indication field may be an existing indication field in the DCI for data scheduling. This indication field may be used to jointly indicate the uplink transmission waveform used by the terminal for PUSCH transmission. For example, the first redefined information indication field in the DCI for data scheduling indicates that the uplink transmission waveform used by the terminal for PUSCH transmission is CP-OFDM waveform. Alternatively, the first redefined information indication field in the DCI for data scheduling indicates that the uplink transmission waveform used by the terminal for PUSCH transmission is DFTS-OFDM waveform.

In some embodiments, the first redefined information indication field may be an existing indication field in the DCI for data scheduling. For example, the existing indication field may be extended so that the existing indication field may carry the waveform indication information. For example, the existing indication field in the DCI for data scheduling may be extended, and the extended existing indication field may be used as the first redefined information indication field.

For example, the DCI for data scheduling may include an indication field for indicating information A. The indication field of information A may be used to indicate the first other information, such as indicating information A. The indication field of information A may be extended so that different portions of information A may respectively correspond to different waveforms. For example, a portion of information A may correspond to CP-OFDM waveform, and another portion of information A may correspond to DFTS-OFDM waveform.

Taking Table 1 as an example, A1, A2, and A3 may be the existing information A in the first redefined information indication field. The relationship between A1, A2, and A3 and a certain waveform, such as the CP-OFDM waveform, may be established. Information A may be extended and newly added, such as A4, A5, and A6, and a relationship between A4, A5, and A6 and another waveform, such as the DFTS-OFDM waveform, may be established. It can be understood that the extended and newly added information A may be the information A that is pre-reserved but unused.

Taking Table 2 as an example, A1, A2, and A3 may be the existing information A in the first redefined information indication field. The relationship between A1, A2, and A3 and a certain waveform, such as the CP-OFDM waveform, may be established. Information A may be extended and newly added, such as A4 and A5, and a relationship between A4 and A5 and another waveform, such as the DFTS-OFDM waveform, may be established. It can be understood that the extended and newly added information A may be the information A that is pre-reserved but unused.

Taking Table 3 as an example, A1, A2, and A3 may be the existing information A in the first redefined information indication field. The relationship between A1 and A2 and a certain waveform, such as the CP-OFDM waveform, may be established. Information A may be extended and newly added, such as A4, and a relationship between A3 and A4 and another waveform, such as the DFTS-OFDM waveform, may be established. It can be understood that the extended and newly added information A may be the information A that is pre-reserved but unused.

Taking Table 4 as an example, A1, A2, and A3 may be the existing information A in the first redefined information indication field. The relationship between A1 and A2 and a certain waveform, such as the CP-OFDM waveform, may be established. Information A may be extended and newly added, such as A4 and A5, and a relationship between A3, A4, and A5 and another waveform, such as the DFTS-OFDM waveform, may be established. It can be understood that the extended and newly added information A may be the information A that is pre-reserved but unused.

It can be understood that the number of information A corresponding to different waveforms in the first redefined information indication field may be identical or different.

In some embodiments, the uplink transmission waveform used by the terminal for PUSCH transmission indicated in Table 1, Table 2, Table 3, and Table 4 above can be explicitly indicated or implicitly indicated. For example, explicit indication means that when configuring the first redefined information indication field, i.e., when configuring information A, indication information in which information A corresponds to different waveforms is added. For example, the uplink transmission waveform used by the terminal for PUSCH transmission is directly indicated by the waveform indication information in the first redefined information indication field, for example, a value of 0 in the first redefined information indication field indicates that the waveform indication information indicates that the uplink transmission waveform used by the terminal for PUSCH transmission is CP-OFDM waveform, or a value of 1 in the first redefined information indication field indicates that the waveform indication information indicates that the uplink transmission waveform used by the terminal for PUSCH transmission is DFTS-OFDM waveform. Alternatively, the value in the first redefined information indication field may correspond to the transform precoding, and the uplink transmission waveform used by the terminal for PUSCH transmission is indicated based on whether the transform precoding in the RRC is enabled or disabled.

For another example, the correspondence between information A and the waveform may be preset, and the uplink transmission waveform used by the terminal for PUSCH transmission is indicated by combining the specific information A carried in the first redefined information indication field and the preset correspondence between information A and the waveform. For example, taking Table 1 as an example, the first redefined information indication field may carry information A3. The waveform corresponding to information A3 is preconfigured as the CP-OFDM waveform. Then, based on the information A3 carried in the first redefined information indication field, it can be implicitly indicated that the uplink transmission waveform used by the terminal for PUSCH transmission is CP-OFDM waveform.

It can be understood that the above correspondence between specific values and waveforms are merely exemplary description, and the present disclosure is not limited thereto.

In some embodiments, the first redefined information indication field may be an existing indication field in the DCI for data scheduling. For example, in the existing indication field, the corresponding information may have already been configured to correspond to different waveforms. Then, such information may be used to jointly indicate the uplink transmission waveform used by the terminal for PUSCH transmission.

For example, the DCI for data scheduling may include an indication field for indicating information B. The indication field of information B may be used to indicate the first other information, such as indicating information B. It is assumed that a relationship between information B and the waveform has been pre-established, that is, different portions of information B may respectively correspond to different waveforms. For example, a portion of information B may correspond to CP-OFDM waveform, and another portion may correspond to DFTS-OFDM waveform.

For example, taking Table 5 as an example, B1, B2, B3, B4, B5, and B6 may be the existing information B in the first redefined information indication field. The relationship between B1, B2, and B3 and a certain waveform, such as the CP-OFDM waveform, is pre-established. The relationship between B4, B5, and B6 and another waveform, such as the DFTS-OFDM waveform, is pre-established. The uplink transmission waveform used by the terminal for PUSCH transmission may be indicated by the existing information B in the first redefined information indication field and the pre-established relationship between information B and the waveform.

The present disclosure jointly indicates the uplink transmission waveform used by the terminal for PUSCH transmission through the existing indication field in the DCI for data scheduling, enabling the DCI for data scheduling to carry the waveform indication information, furthermore, the second DCI may perform scheduling based on the same uplink transmission waveform, thereby reducing the overhead of the second DCI and enhancing the uplink coverage.

In the configuration method of the uplink waveform provided by the embodiments of the present disclosure, the first redefined information indication field is the indication field corresponding to the first other information.

In some embodiments, the information corresponding to the first redefined information indication field may be a certain code point, such as 0, 1, 2, 3, 4, etc. This code point may be the code point corresponding to the first other information. Different code point values may correspond to different information in the corresponding indication field. For example, it is assumed that the first redefined information indication field corresponds to information A, code point 0 may correspond to A1, code point 1 may correspond to A2, and so on. Then, different code point values may correspond to different uplink transmission waveforms used by the terminal for PUSCH transmission.

In some embodiments, the information corresponding to the first redefined information indication field may be the first other information, where the first other information is any information other than the waveform. For example, assuming that the first other information is information A, the first redefined information indication field may directly carry the corresponding information A to correspond to the uplink transmission waveform used by the terminal for PUSCH transmission. For example, the indication is made through the waveform correspondence shown in Table 1, Table 2, Table 3, Table 4, or Table 5 above.

The present disclosure can indicate the uplink transmission waveform used by the terminal for PUSCH transmission through the code point or the indication information contained in the indication field of the first other information, enabling the DCI for data scheduling to carry the waveform indication information, furthermore, the second DCI may perform scheduling based on the same uplink transmission waveform, thereby reducing the overhead of the second DCI and enhancing the uplink coverage.

In the configuration method of the uplink waveform provided by the embodiments of the present disclosure, the first other information is the BWP indication information or the code point corresponding to the BWP; and/or, the first other information is the DMRS port indication information or the code point corresponding to the DMRS port.

In some embodiments, the first other information may be the BWP indication information or the code point corresponding to the BWP. This enables the DCI for data scheduling to indicate the uplink transmission waveform used by the terminal for PUSCH transmission based on the BWP indication information or the code point corresponding to the BWP.

In some embodiments, the first other information may be the DMRS port indication information or the code point corresponding to the DMRS port. This enables the DCI for data scheduling to indicate the uplink transmission waveform used by the terminal for PUSCH transmission based on the DMRS port indication information or the code point corresponding to the DMRS port.

The present disclosure can explicitly or implicitly indicate the uplink transmission waveform used by the terminal for PUSCH transmission through the BWP or the DMRS port, enabling the DCI for data scheduling to use the indication field corresponding to the first other information to carry the waveform indication information, furthermore, the second DCI may perform scheduling based on the same uplink transmission waveform, thereby reducing the overhead of the second DCI and enhancing the uplink coverage.

In the configuration method of the uplink waveform provided by the embodiments of the present disclosure, the first DCI is DCI without data scheduling, and the waveform indication information is carried in the second newly added information indication field and/or the second redefined information indication field of the first DCI.

In some embodiments, the network device sending the first DCI may be the network device sending a DCI without data scheduling. The DCI without data scheduling may include a second newly added information indication field and/or a second redefined information indication field. The second newly added information indication field and/or the second redefined information indication field may be used to carry the waveform indication information.

In some embodiments, the DCI without data scheduling is a DCI for SPS release and a DCI for beam indication. For example, in R17, the DCI without data scheduling may include DCI 1_1 and DCI 1_2.

For example, FIG. 5 shows a schematic structural diagram of a possible DCI without data scheduling. The DCI without data scheduling includes a second newly added information indication field and/or a second redefined information indication field. The DCI without data scheduling may carry the waveform indication information through the second newly added information indication field and/or the second redefined information indication field.

The present disclosure uses the DCI without data scheduling to carry the waveform indication information to indicate the uplink transmission waveform used by the terminal for PUSCH transmission, so that the second DCI may perform scheduling based on the same uplink transmission waveform, thereby reducing the overhead of the second DCI and enhancing the uplink coverage.

In the configuration method of the uplink waveform provided by the embodiments of the present disclosure, the second newly added information indication field is an information indication field newly added in the DCI without data scheduling and used to indicate the uplink transmission waveform used by the terminal for PUSCH transmission.

In some embodiments, the second newly added information indication field may be an indication field newly added in the DCI for data scheduling. This indication field is used to indicate the uplink transmission waveform used by the terminal for PUSCH transmission. For example, the second newly added information indication field in the DCI for data scheduling indicates that the uplink transmission waveform used by the terminal for PUSCH transmission is CP-OFDM waveform. Alternatively, the second newly added information indication field in the DCI for data scheduling indicates that the uplink transmission waveform used by the terminal for PUSCH transmission is DFTS-OFDM waveform.

For example, assuming that the original DCI without data scheduling includes N indication fields, the DCI without data scheduling involved in the present disclosure may include N+1 indication fields. That is, compared with the original DCI without data scheduling, the DCI without data scheduling of the present disclosure is newly added with one second newly added information indication field. The newly added second newly added information indication field may be used to carry the waveform indication information.

In some embodiments, the second newly added information indication field may be a 1 bit indication field, which is used to indicate the uplink transmission waveform used by the terminal for PUSCH transmission. For example, the second newly added information indication field is 0, which may be used to indicate that the uplink transmission waveform used by the terminal for PUSCH transmission is CP-OFDM waveform. The second newly added information indication field is 1, which may be used to indicate that the uplink transmission waveform used by the terminal for PUSCH transmission is DFTS-OFDM waveform. For another example, the second newly added information indication field is 0, which may be used to indicate that the uplink transmission waveform used by the terminal for PUSCH transmission is DFTS-OFDM waveform. The second newly added information indication field is 1, which may be used to indicate that the uplink transmission waveform used by the terminal for PUSCH transmission is CP-OFDM waveform. It can be understood that the present disclosure does not limit the correspondence between the specific values in the second newly added information indication field and the corresponding waveforms. The specific association can be adjusted arbitrarily according to the actual situation.

The present disclosure newly adds an information indication field in the DCI for data scheduling to indicate the uplink transmission waveform used by the terminal for PUSCH transmission, enabling the DCI for data scheduling to carry the waveform indication information to indicate the uplink transmission waveform used by the terminal for PUSCH transmission, furthermore, the second DCI may perform scheduling based on the same uplink transmission waveform, thereby reducing the overhead of the second DCI and enhancing the uplink coverage.

In the configuration method of the uplink waveform provided by the embodiments of the present disclosure, the second redefined information indication field is used to jointly indicate the uplink transmission waveform used by the terminal for PUSCH transmission; the second redefined information indication field is also used to indicate the second other information, there is a predefined explicit or implicit correspondence between the second other information and the uplink transmission waveform, and the second other information is information other than the information indicating the uplink transmission waveform.

In some embodiments, the second redefined information indication field may be an existing indication field in the DCI without data scheduling. This indication field may be used to jointly indicate the uplink transmission waveform used by the terminal for PUSCH transmission. For example, the second redefined information indication field in the DCI without data scheduling indicates that the uplink transmission waveform used by the terminal for PUSCH transmission is CP-OFDM waveform. Alternatively, the second redefined information indication field in the DCI without data scheduling indicates that the uplink transmission waveform used by the terminal for PUSCH transmission is DFTS-OFDM waveform.

In some embodiments, the second redefined information indication field may be an existing indication field in the DCI for data scheduling. For example, the existing indication field may be extended so that the existing indication field may carry the waveform indication information. For example, the existing indication field in the DCI without data scheduling may be extended, and the extended existing indication field may be used as the second redefined information indication field.

It can be understood that extending the second redefined information indication field may be achieved by using the existing indication field that is undefined or unused.

For example, the DCI without data scheduling may include an indication field for indicating information C. The indication field of information C may be used to indicate the second other information, such as indicating information C. The indication field of information C may be extended so that different portions of information C may respectively correspond to different waveforms. For example, a portion of information C may correspond to CP-OFDM waveform, and another portion of information C may correspond to DFTS-OFDM waveform.

For example, taking Table 7 as an example, C1, C2, and C3 may be the existing information C in the second redefined information indication field. A relationship between C1, C2, and C3 and a certain waveform, such as the CP-OFDM waveform, may be established. Information C may be extended and newly added, such as C4, C5, and C6, and a relationship between C4, C5, and C6 and another waveform, such as the DFTS-OFDM waveform, may be established. It can be understood that the extended and newly added information C may be the information C that is pre-reserved but unused or the undefined information C.

For example, taking Table 8 as an example, C1, C2, and C3 may be the existing information C in the second redefined information indication field. A relationship between C1, C2, and C3 and a certain waveform, such as the CP-OFDM waveform, may be established. Information C may be extended and newly added, such as C4 and C5, and a relationship between C4 and C5 and another waveform, such as the DFTS-OFDM waveform, may be established. It can be understood that the extended and newly added information C may be the information C that is pre-reserved but unused or the undefined information C.

For example, taking Table 9 as an example, C1, C2, and C3 may be the existing information C in the second redefined information indication field. A relationship between C1 and C2 and a certain waveform, such as the CP-OFDM waveform, may be established. Information C may be extended and newly added, such as C4, and a relationship between C3 and C4 and another waveform, such as the DFTS-OFDM waveform, may be established. It can be understood that the extended and newly added information C may be the information C that is pre-reserved but unused or the undefined information C.

For example, taking Table 10 as an example, C1, C2, and C3 may be the existing information C in the second redefined information indication field. A relationship between C1 and C2 and a certain waveform, such as the CP-OFDM waveform, may be established. Information C may be extended and newly added, such as C4 and C5, and a relationship between C3, C4, and C5 and another waveform, such as the DFTS-OFDM waveform, may be established. It can be understood that the extended and newly added information C may be the information C that is pre-reserved but unused or the undefined information C.

It can be understood that the number of information C corresponding to different waveforms in the second redefined information indication field may be identical or different.

In some embodiments, the uplink transmission waveform used by the terminal for PUSCH transmission indicated in Table 7, Table 8, Table 9, and Table 10 above can be explicitly indicated or implicitly indicated. For example, explicit indication means that when configuring the second redefined information indication field, i.e., when configuring information C, indication information in which information C corresponds to different waveforms is added. For example, the uplink transmission waveform used by the terminal for PUSCH transmission is directly indicated by the waveform indication information in the second redefined information indication field, for example, a value of 0 in the second redefined information indication field indicates that the waveform indication information indicates that the uplink transmission waveform used by the terminal for PUSCH transmission is CP-OFDM waveform, or a value of 1 in the second redefined information indication field indicates that the waveform indication information indicates that the uplink transmission waveform used by the terminal for PUSCH transmission is DFTS-OFDM waveform. Alternatively, the value in the second redefined information indication field may correspond to the transform precoding, and the uplink transmission waveform used by the terminal for PUSCH transmission is indicated based on whether the transform precoding in the RRC is enabled or disabled.

For another example, the correspondence between information C and the waveform may be preset, the uplink transmission waveform used by the terminal for PUSCH transmission is indicated by combining the specific information C carried in the second redefined information indication field and the preset correspondence between information C and the waveform. For example, taking Table 7 as an example, the second redefined information indication field may carry information C3. The waveform corresponding to information C3 is pre-configured as the CP-OFDM waveform. Then, based on the information C3 carried in the second redefined information indication field, it can be implicitly indicated that the uplink transmission waveform used by the terminal for PUSCH transmission is CP-OFDM waveform.

It can be understood that the above correspondence between specific values and waveforms are merely exemplary description, and the present disclosure is not limited thereto.

In some embodiments, the second redefined information indication field may be an existing indication field in the DCI without data scheduling. For example, in the existing indication field, the corresponding information may have already been configured to correspond to different waveforms. Then, such information may be used to jointly indicate the uplink transmission waveform used by the terminal for PUSCH transmission.

It can be understood that such second redefined information indication field may be an indication field that has been defined or used.

For example, the DCI without data scheduling may include an indication field for indicating information D. The indication field of information D may be used to indicate the first other information, such as indicating information D. It is assumed that a relationship between information D and the waveform has been pre-established, that is, different portions of information D may respectively correspond to different waveforms. For example, a portion of information D may correspond to CP-OFDM waveform, and another portion of information D may correspond to DFTS-OFDM waveform.

For example, taking Table 11 as an example, D1, D2, D3, D4, D5, and D6 may be the existing information D in the second redefined information indication field. The relationship between D1, D2, and D3 and a certain waveform, such as the CP-OFDM waveform, is pre-established. The relationship between D4, D5, and D6 and another waveform, such as the DFTS-OFDM waveform, is pre-established. The uplink transmission waveform used by the terminal for PUSCH transmission may be indicated by the existing information D in the second redefined information indication field and the pre-established relationship between information D and the waveform.

The present disclosure jointly indicates the uplink transmission waveform used by the terminal for PUSCH transmission through the existing indication field in the DCI for data scheduling, enabling the DCI for data scheduling to carry the waveform indication information, furthermore, the second DCI may perform scheduling based on the same uplink transmission waveform, thereby reducing the overhead of the second DCI and enhancing the uplink coverage.

In the configuration method of the uplink waveform provided by the embodiments of the present disclosure, the second redefined information indication field is the indication field corresponding to the second other information.

In some embodiments, the information corresponding to the second redefined information indication field may be a certain code point, such as 0, 1, 2, 3, 4, etc. This code point may be the code point corresponding to the second other information. Different code point values may correspond to different information in the corresponding indication field. For example, it is assumed that the second redefined information indication field corresponds to information C, code point 0 may correspond to C1, code point 1 may correspond to C2, and so on. Then, different code point values may correspond to different uplink transmission waveforms used by the terminal for PUSCH transmission.

In some embodiments, the information corresponding to the second redefined information indication field may be the second other information, where the second other information is any information other than the waveform. For example, assuming that the second other information is information C, the second redefined information indication field may directly carry the corresponding information C to correspond to the uplink transmission waveform used by the terminal for PUSCH transmission. For example, the indication is made through the waveform correspondence shown in Table 7, Table 8, Table 9, Table 10, or Table 11 above.

The present disclosure can indicate the uplink transmission waveform used by the terminal for PUSCH transmission through the indication information contained in the indication field of the second other information or the code point, enabling the DCI for data scheduling to carry the waveform indication information, furthermore, the second DCI may perform scheduling based on the same uplink transmission waveform, thereby reducing the overhead of the second DCI and enhancing the uplink coverage.

In the configuration method of the uplink waveform provided by the embodiments of the present disclosure, the second other information is the DMRS sequence initialization information or the code point corresponding to the DMRS sequence initialization information; and/or, the second other information is the TDRA indication information or the code point corresponding to the TDRA.

In some embodiments, the second other information may be the DMRS sequence initialization information or the code point corresponding to the DMRS sequence initialization information, and the indication field corresponding to the second other information may be DMRS sequence initialization. For example, the indication field of DMRS sequence initialization uses 1 bit to carry the waveform indication information to indicate the uplink transmission waveform used by the terminal for PUSCH transmission.

In some embodiments, the second other information may be the TDRA indication information or the code point corresponding to the TDRA. For example, the TDRA may be pre-configured with a correspondence with the waveform, and then based on the TDRA indication information or the code point corresponding to the TDRA, the uplink transmission waveform used by the terminal for PUSCH transmission may be indicated.

The present disclosure can explicitly or implicitly indicate the uplink transmission waveform used by the terminal for PUSCH transmission through the DMRS sequence initialization information or the TDRA, enabling the DCI for data scheduling to use the indication field corresponding to the second other information to carry the waveform indication information, furthermore, the second DCI may perform scheduling based on the same uplink transmission waveform, thereby reducing the overhead of the second DCI and enhancing the uplink coverage.

In the configuration method of the uplink waveform provided by the embodiments of the present disclosure, the first DCI is GC DCI, and the waveform indication information is carried in the GC DCI.

In some embodiments, the terminal receiving the first DCI may be the terminal receiving the GC DCI. The waveform indication information may be carried in the GC DCI received by the terminal. For example, as shown in FIG. 6, the GC DCI includes an indication field carrying the waveform indication information.

The present disclosure uses the GC DCI to carry the waveform indication information to indicate the uplink transmission waveform used by the terminal for PUSCH transmission, so that the second DCI may perform scheduling based on the same uplink transmission waveform, thereby reducing the overhead of the second DCI and enhancing the uplink coverage.

In the configuration method of the uplink waveform provided by the embodiments of the present disclosure, the GC DCI is the group control indication information used to carry the uplink transmission waveform used by the terminal for PUSCH transmission.

In some embodiments, the GC DCI received by the terminal may be GC DCI dedicated to carry the uplink transmission waveform used by the terminal for PUSCH transmission. It can be understood that such GC DCI is a new GC DCI different from the existing GC DCI. In the related art, the existing GC DCI is mainly used to indicate the downlink control information of a plurality of different terminals within a specific group. The existing GC DCI does not contain the waveform indication information used to indicate the uplink transmission waveform used by the terminal for PUSCH transmission. Therefore, a GC DCI may be constructed, which may be used to indicate the uplink transmission waveforms used by a plurality of different terminals within a specific group for PUSCH transmission. Compared with the existing GC DCI, such GC DCI can indicate the uplink transmission waveforms used by a plurality of different terminals within a specific group for PUSCH transmission.

The present disclosure constructs a GC DCI used to carry the uplink transmission waveform used by the terminal for PUSCH transmission, so that the second DCI may perform scheduling based on the same uplink transmission waveform, thereby reducing the overhead of the second DCI and enhancing the uplink coverage.

In the configuration method of the uplink waveform provided by the embodiments of the present disclosure, the GC DCI includes a newly added third newly added information indication field used to indicate the uplink transmission waveform used by the terminal for PUSCH transmission; the GC DCI is also used to indicate the waveform indication information respectively corresponding to a plurality of terminals within a specific group.

In some embodiments, the GC DCI received by the terminal may include a newly added third newly added information indication field used to indicate the uplink transmission waveform used by the terminal for PUSCH transmission. This GC DCI may be used to indicate the waveform indication information respectively corresponding to a plurality of terminals within a specific group. For example, this GC DCI may be an existing GC DCI. The existing GC DCI should contain the newly added third newly added information indication field, so that the existing GC DCI containing the third newly added information indication field can indicate the uplink transmission waveform used by the terminal for PUSCH transmission.

In some embodiments, the third newly added information indication field may be an indication field newly added in the GC DCI. This indication field is used to indicate the uplink transmission waveform used by the terminal for PUSCH transmission. For example, the third newly added information indication field in the GC DCI indicates that the uplink transmission waveform used by the terminal for PUSCH transmission is CP-OFDM waveform. Alternatively, the first newly added information indication field in the GC DCI indicates that the uplink transmission waveform used by the terminal for PUSCH transmission is DFTS-OFDM waveform.

For example, assuming that the original GC DCI includes M indication fields, the GC DCI involved in the present disclosure may include M+1 indication fields. For example, as shown in FIG. 7, compared with the original GC DCI, the GC DCI of the present disclosure is newly added with one third newly added information indication field. The newly added third newly added information indication field may be used to carry the waveform indication information.

In some embodiments, the third newly added information indication field may be a 1 bit indication field, which is used to indicate the uplink transmission waveform used by the terminal for PUSCH transmission. For example, the third newly added information indication field is 0, which may be used to indicate that the uplink transmission waveform used by the terminal for PUSCH transmission is CP-OFDM waveform. The third newly added information indication field is 1, which may be used to indicate that the uplink transmission waveform used by the terminal for PUSCH transmission is DFTS-OFDM waveform. For another example, the third newly added information indication field is 0, which may be used to indicate that the uplink transmission waveform used by the terminal for PUSCH transmission is DFTS-OFDM waveform. The third newly added information indication field is 1, which may be used to indicate that the uplink transmission waveform used by the terminal for PUSCH transmission is CP-OFDM waveform. It can be understood that the present disclosure does not limit the correspondence between the specific values in the third newly added information indication field and the corresponding waveforms, which can be adjusted arbitrarily according to the actual situation.

In some embodiments, for example, the GC DCI may be DCI2-3, and a 1 bit third newly added information indication field may be added to DCI2-3 to independently indicate the uplink transmission waveform used by the terminal for PUSCH transmission.

The present disclosure newly adds an information indication field in the GC DCI to indicate the uplink transmission waveform used by the terminal for PUSCH transmission, enabling the GC DCI to carry the waveform indication information to indicate the uplink transmission waveform used by the terminal for PUSCH transmission, furthermore, the second DCI may perform scheduling based on the same uplink transmission waveform, thereby reducing the overhead of the second DCI and enhancing the uplink coverage.

In the configuration method of the uplink waveform provided by the embodiments of the present disclosure, the GC DCI includes a third redefined information indication field used to jointly indicate the uplink transmission waveform used by the terminal for PUSCH transmission; the third redefined information indication field is also used to indicate the third other information, there is a predefined explicit or implicit correspondence between the third other information and the uplink transmission waveform, and the third other information is information other than the information indicating the uplink transmission waveform.

In some embodiments, the GC DCI received by the terminal may include a third redefined information indication field used to jointly indicate the uplink transmission waveform used by the terminal for PUSCH transmission. This GC DCI may also be used to indicate the third other information. For example, this GC DCI may be an existing GC DCI. The existing GC DCI should contain the third redefined information indication field, so that the existing GC DCI containing the third redefined information indication field can indicate the uplink transmission waveform used by the terminal for PUSCH transmission. For example, as shown in FIG. 8, it can be seen that the GC DCI includes a third redefined information indication field, and the third redefined information indication field carries the waveform indication information to indicate the uplink transmission waveform used by the terminal for PUSCH transmission.

In some embodiments, the third redefined information indication field may be an existing indication field in the GC DCI. This indication field may be used to jointly indicate the uplink transmission waveform used by the terminal for PUSCH transmission. For example, the third redefined information indication field in the GC DCI indicates that the uplink transmission waveform used by the terminal for PUSCH transmission is CP-OFDM waveform. Alternatively, the third redefined information indication field in the GC DCI indicates that the uplink transmission waveform used by the terminal for PUSCH transmission is DFTS-OFDM waveform.

In some embodiments, the third redefined information indication field may be an existing indication field in the GC DCI. For example, the existing indication field may be extended so that the existing indication field may carry the waveform indication information. For example, the existing indication field in the GC DCI may be extended, and the extended existing indication field may be used as the third redefined information indication field. For example, the GC DCI may include an indication field for indicating information E. The indication field of information E may be used to indicate the third other information, such as indicating information E. The indication field of information E may be extended so that different portions of information E may respectively correspond to different waveforms. For example, a portion of information E may correspond to CP-OFDM waveform, and another portion of information E may correspond to DFTS-OFDM waveform.

For example, taking Table 12 as an example, E1, E2, and E3 may be the existing information E in the third redefined information indication field. A relationship between E1, E2, and E3 and a certain waveform, such as the CP-OFDM waveform, may be established. Information E may be extended and newly added, such as E4, E5, and E6, and a relationship between E4, E5, and E6 and another waveform, such as the DFTS-OFDM waveform, may be established. It can be understood that the extended and newly added information E may be the information E that is pre-reserved but unused.

For example, taking Table 13 as an example, E1, E2, and E3 may be the existing information E in the third redefined information indication field. A relationship between E1, E2, and E3 and a certain waveform, such as the CP-OFDM waveform, may be established. Information E may be extended and newly added, such as E4 and E5, and a relationship between E4 and E5 and another waveform, such as the DFTS-OFDM waveform, may be established. It can be understood that the extended and newly added information E may be the information E that is pre-reserved but unused.

For example, taking Table 14 as an example, E1, E2, and E3 may be the existing information E in the third redefined information indication field. A relationship between E1 and E2 and a certain waveform, such as the CP-OFDM waveform, may be established. Information E may be extended and newly added, such as E4, and a relationship between E3 and E4 and another waveform, such as the DFTS-OFDM waveform, may be established. It can be understood that the extended and newly added information E may be the information E that is pre-reserved but unused.

For example, taking Table 15 as an example, E1, E2, and E3 may be the existing information E in the third redefined information indication field. A relationship between E1 and E2 and a certain waveform, such as the CP-OFDM waveform, may be established. Information E may be extended and newly added, such as E4 and E5, and a relationship between E3, E4, and E5 and another waveform, such as the DFTS-OFDM waveform, may be established. It can be understood that the extended and newly added information E may be the information E that is pre-reserved but unused.

It can be understood that the number of information E corresponding to different waveforms in the third redefined information indication field may be identical or different.

In some embodiments, the uplink transmission waveform used by the terminal for PUSCH transmission indicated in Table 12, Table 13, Table 14, and Table 15 above can be explicitly indicated or implicitly indicated. For example, explicit indication means that when configuring the third redefined information indication field, i.e., when configuring information E, indication information in which information E corresponds to different waveforms is added. For example, the uplink transmission waveform used by the terminal for PUSCH transmission is directly indicated by the waveform indication information in the third redefined information indication field, for example, a value of 0 in the third redefined information indication field indicates that the waveform indication information indicates that the uplink transmission waveform used by the terminal for PUSCH transmission is CP-OFDM waveform, or a value of 1 in the third redefined information indication field indicates that the waveform indication information indicates that the uplink transmission waveform used by the terminal for PUSCH transmission is DFTS-OFDM waveform. Alternatively, the value in the third redefined information indication field may correspond to the transform precoding, and the uplink transmission waveform used by the terminal for PUSCH transmission is indicated based on whether the transform precoding in the RRC is enabled or disabled.

For another example, the correspondence between information E and the waveform may be preset, and the uplink transmission waveform used by the terminal for PUSCH transmission is indicated by combining the specific information E carried in the third redefined information indication field and the preset correspondence between information E and the waveform. For example, taking Table 12 as an example, the third redefined information indication field may carry information E3. The waveform corresponding to information E3 is pre-configured as the CP-OFDM waveform. Then, based on the information E3 carried in the third redefined information indication field, it can be implicitly indicated that the uplink transmission waveform used by the terminal for PUSCH transmission is CP-OFDM waveform.

It can be understood that the above correspondence between specific values and waveforms are merely exemplary description, and the present disclosure is not limited thereto.

In some embodiments, the third redefined information indication field may be an existing indication field in the GC DCI. For example, in the existing indication field, the corresponding information may have already been configured to correspond to different waveforms. Then, such information may be used to jointly indicate the uplink transmission waveform used by the terminal for PUSCH transmission.

For example, the GC DCI may include an indication field for indicating information F. The indication field of information F may be used to indicate the third other information, such as indicating information F. It is assumed that a relationship between information F and the waveform has been pre-established, that is, different portions of information F may respectively correspond to different waveforms. For example, a portion of information F may correspond to CP-OFDM waveform, and another portion of information F may correspond to DFTS-OFDM waveform.

For example, taking Table 16 as an example, F1, F2, F3, F4, F5, and F6 may be the existing information F in the third redefined information indication field. The relationship between F1, F2, and F3 and a certain waveform, such as the CP-OFDM waveform, is pre-established. The relationship between F4, F5, and F6 and another waveform, such as the DFTS-OFDM waveform, is pre-established. The uplink transmission waveform used by the terminal for PUSCH transmission may be indicated by the existing information F in the third redefined information indication field and the pre-established relationship between information F and the waveform.

In some embodiments, the information corresponding to the third redefined information indication field may be a certain code point, such as 0, 1, 2, 3, 4, etc. Different code point values may correspond to different information in the corresponding indication field. For example, it is assumed that the third redefined information indication field corresponds to information E, code point 0 may correspond to E1, code point 1 may correspond to E2, and so on. Then, different code point values may correspond to different uplink transmission waveforms used by the terminal for PUSCH transmission.

In some embodiments, the information corresponding to the third redefined information indication field may be the third other information, where the third other information is any information other than the waveform. For example, assuming that the third other information is information E, the third redefined information indication field may directly carry the corresponding information E to correspond to the uplink transmission waveform used by the terminal for PUSCH transmission. For example, the indication is made through the waveform correspondence shown in Table 12, Table 13, Table 14, Table 15, or Table 16 above.

The present disclosure jointly indicates the uplink transmission waveform used by the terminal for PUSCH transmission through the existing indication field in the GC DCI, enabling the GC DCI to carry the waveform indication information, furthermore, the second DCI may perform scheduling based on the same uplink transmission waveform, thereby reducing the overhead of the second DCI and enhancing the uplink coverage.

In the configuration method of the uplink waveform provided by the embodiments of the present disclosure, the PUSCH includes at least one of the following: PUSCH of configured grant type 1; PUSCH of configured grant type 2; dynamic grant (DG) PUSCH.

In some embodiments, the PUSCH may be the PUSCH of configured grant type 1, such as CG PUSCH Type 1.

CG PUSCH represents the grant-free PUSCH, and Type 1 is a grant-free scheduling scheme of CG PUSCH. In CG PUSCH Type 1, the uplink grant, including the activation of the grant, is provided by the RRC. Once the terminal correctly receives the RRC configuration, it takes effect immediately. The terminal configures all the transmission parameters through the RRC signaling, including the period, time offset, and frequency resources, as well as the modulation and coding scheme used for the uplink transmission. After the terminal receives the RRC configuration, at the moment given by the period and offset, the terminal starts to use the configured grant for transmission. The offset is used to control at which moment the terminal is permitted to transmit.

In some embodiments, the PUSCH may be the PUSCH of configured grant type 2, such as CG PUSCH Type 2.

In CG PUSCH Type 2, the RRC provides the transmission period, and the base station realizes the resource activation and the configuration of some transmission parameters through the DCI, so as to realize the activation and transmission of this grant configuration. After the terminal receives the activation command, if there is data to be sent in the buffer, it may be transmitted according to the pre-configured period; if there is no data, the terminal will not transmit any data. The sending time of the PDCCH defines the activation time. The terminal confirms the activation/deactivation of the configured grant type 2 by sending the MAC control signaling on the uplink.

It can be understood that the difference between CG PUSCH Type 1 and CG PUSCH Type 2 lies in the; activation manner.

In some embodiments, the PUSCH may be the DG PUSCH.

The present disclosure can be applied to different types of PUSCH scenarios, so that in the case of different PUSCH configurations, by receiving the first DCI to indicate the uplink transmission waveform used by the terminal for PUSCH transmission, the second DCI may perform scheduling based on the same uplink transmission waveform, thereby reducing the overhead of the second DCI and enhancing the uplink coverage.

In the configuration method of the uplink waveform provided by the embodiments of the present disclosure, the first DCI includes DCI 0_1, DCI 0_2, DCI 1_1 and/or downlink DCI 1_2.

In some embodiments, the first DCI may be DCI 0_1, DCI 0_2, DCI 1_1 and/or downlink DCI 1_2.

In some embodiments, the uplink DCI may be indicated only when it is DCI 0_1 and/or DCI 0_2.

The present disclosure can be applied to scenarios of different types of DCI, so that in scenarios of different types of DCI, by receiving the first DCI to indicate the uplink transmission waveform used by the terminal for PUSCH transmission, the second DCI may perform scheduling based on the same uplink transmission waveform, thereby reducing the overhead of the second DCI and enhancing the uplink coverage.

In some implementations, the present disclosure provides an approach for the extension of the DMRS port. This realizes the joint indication of the indication fields of other information in the DCI for data scheduling or the GC DCI.

For example, Table 17 shows an extended DMRS port indication table.

TABLE 17

| | Number of DMRS CDM | DMRS |
|---|---|---|
| Value | group(s) without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6 | 2 | 0 |
| 7 | 2 | 1 |
| 8 | 2 | 2 |
| 9 | 2 | 3 |
| 10-15 | Reserved | Reserved |

The value of each row may be regarded as a code point. Different code points may correspond to different DMRS ports. It can be set that the code points 0-5 correspond to CP-OFDM waveform, and the code points 6-9 correspond to the DFT-S-OFDM waveform. It can be understood that 10-15 may be the reserved bits that are preset but not activated. Obviously, Table 11 gives an approach of implicit indication.

Meanwhile, the code points 6-9 may be newly added and extended, that is, the DMRS port indication may originally only be configured with code points 0-5 and not associated with the waveform.

In some implementations, the present disclosure provides another approach for the extension of the DMRS port. This realizes the joint indication of the indication fields of other information in the DCI for data scheduling or the GC DCI.

For example, Table 18 shows another extended DMRS port indication table.

TABLE 18

| | Number of DMRS CDM | DMRS | |
|---|---|---|---|
| Value | group(s) without data | port(s) | waveform |
| 0 | 1 | 0 | CP-OFDM |
| 1 | 1 | 1 | |
| 2 | 2 | 0 | |
| 3 | 2 | 1 | |
| 4 | 2 | 2 | |
| 5 | 2 | 3 | |
| 6 | 2 | 0 | Transform |
| 7 | 2 | 1 | precoding |
| 8 | 2 | 2 | |
| 9 | 2 | 3 | |
| 10-15 | Reserved | Reserved | |

The value of each row may be regarded as a code point. Different code points may correspond to different DMRS ports. The indication information of the corresponding waveform may be directly added to the table. For example, it is set that the code points 0-5 correspond to CP-OFDM waveform, and the code points 6-9 correspond to the transform precoding. The uplink transmission waveform used by the terminal for PUSCH transmission may be indicated based on whether the transform precoding in the RRC is enabled or disabled. It can be understood that 10-15 may be the reserved bits that are preset but not activated. Obviously, Table 12 gives an approach of explicit indication.

In some implementations, the present disclosure provides an approach for the extension of the BWP indicator field. This realizes the joint indication of the indication fields of other information in the DCI for data scheduling or the GC DCI.

For example, Table 19 shows a table for the extension of the BWP indicator field.

TABLE 19

| Value of BWP | | |
|---|---|---|
| indicator field | | Waveform |
| 2 bits | Bandwidth part | for PUSCH |
| 0 | Configured BWP with BWP-Id = 1 | DFD-S-OFDM |
| 1 | Configured BWP with BWP-Id = 1 | CP-OFDM |
| 2 | Configured BWP with BWP-Id = 2 | DFD-S-OFDM |
| 3 | Configured BWP with BWP-Id = 2 | CP-OFDM |
| 4 | Configured BWP with BWP-Id = 3 | DFD-S-OFDM |
| 5 | Configured BWP with BWP-Id = 3 | CP-OFDM |
| 6 | Configured BWP with BWP-Id = 4 | DFD-S-OFDM |
| 7 | Configured BWP with BWP-Id = 4 | CP-OFDM |

The value of the BWP indicator field in each row may be regarded as a code point. Different code points may correspond to different BWP indicators. For example, since the relationship between different waveforms and different BWP indicators already exists in the table, the BWP indicator may be directly used to indicate the uplink transmission waveform used by the terminal for PUSCH transmission.

It should be noted that those skilled in the art can understand that the various implementations/embodiments involved in the above embodiments of the present disclosure may be used in combination with the above-mentioned embodiments, or may be used independently. Whether being used alone or in combination with the embodiments, the implementation principles are similar. In the implementation of the present disclosure, some embodiments are described in the implementation of being used together. Those skilled in the art can understand that such an illustrative example is not a limitation to the embodiments of the present disclosure.

Based on the same concept, the embodiments of the present disclosure further provide a configuration apparatus and device for an uplink waveform.

It can be understood that in order to achieve the above functions, the configuration apparatus and device for the uplink waveform provided by the embodiments of the present disclosure include the corresponding hardware structures and/or software modules for executing each function. Combining the units and algorithm steps of the examples disclosed in the embodiments of the present disclosure, the embodiments of the present disclosure can be implemented in the form of hardware or a combination of hardware and computer software. Whether a certain function is executed in the way of hardware or computer software driving the hardware depends on the specific application and design constraint conditions of the technical solution. Those skilled in the art can use different methods to implement the described functions for each specific application, but such implementation should not be regarded as going beyond the scope of the technical solutions of the embodiments of the present disclosure.

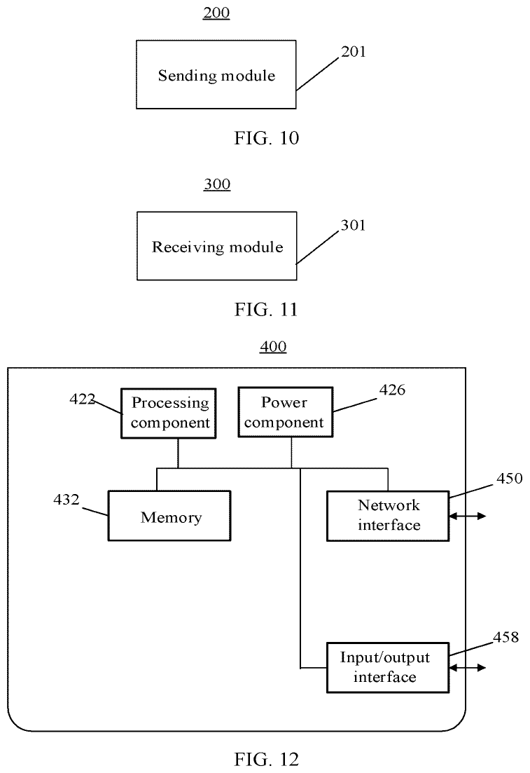

FIG. 10 is a schematic diagram of a configuration apparatus of an uplink waveform according to an exemplary embodiment. Referring to FIG. 10, the apparatus 200 is configured in a network device and includes: a sending module 201, configured to send first downlink control information (DCI), where the first DCI includes waveform indication information, and the waveform indication information is used to indicate an uplink transmission waveform used by the terminal for a physical uplink shared channel (PUSCH) transmission; where the sending module 201 is further configured to send second DCI, and the second DCI performs scheduling using the uplink transmission waveform indicated by the waveform indication information.

The present disclosure indicates the uplink transmission waveform used by the terminal for PUSCH transmission by sending the first DCI, so that the second DCI may perform scheduling based on the same uplink transmission waveform, thereby reducing the overhead of the second DCI and enhancing the uplink coverage.

In one implementation, the first DCI is DCI for data scheduling, and the waveform indication information is carried in a first newly added information indication field and/or a first redefined information indication field in the first DCI.

The present disclosure uses the DCI for data scheduling to carry the waveform indication information to indicate the uplink transmission waveform used by the terminal for PUSCH transmission, so that the second DCI may perform scheduling based on the same uplink transmission waveform, thereby reducing the overhead of the second DCI and enhancing the uplink coverage.

In one implementation, the first newly added information indication field is an information indication field newly added in the DCI for data scheduling and used to indicate the uplink transmission waveform used by the terminal for PUSCH transmission.

The present disclosure newly adds an information indication field in the DCI for data scheduling to indicate the uplink transmission waveform used by the terminal for PUSCH transmission, enabling the DCI for data scheduling to carry the waveform indication information to indicate the uplink transmission waveform used by the terminal for PUSCH transmission, furthermore, the second DCI may perform scheduling based on the same uplink transmission waveform, thereby reducing the overhead of the second DCI and enhancing the uplink coverage.

In one implementation, the first redefined information indication field is used to jointly indicate the uplink transmission waveform used by the terminal for PUSCH transmission; the first redefined information indication field is also used to indicate the first other information, there is a predefined explicit or implicit correspondence between the first other information and the uplink transmission waveform, and the first other information is information other than the information indicating the uplink transmission waveform.

The present disclosure jointly indicates the uplink transmission waveform used by the terminal for PUSCH transmission through the existing indication field in the DCI for data scheduling, enabling the DCI for data scheduling to carry the waveform indication information, furthermore, the second DCI may perform scheduling based on the same uplink transmission waveform, thereby reducing the overhead of the second DCI and enhancing the uplink coverage.

In one implementation, the first redefined information indication field is the indication field corresponding to the first other information.

The present disclosure can indicate the uplink transmission waveform used by the terminal for PUSCH transmission through the code point or the indication information contained in the indication field of other information, enabling the DCI for data scheduling to carry the waveform indication information, furthermore, the second DCI may perform scheduling based on the same uplink transmission waveform, thereby reducing the overhead of the second DCI and enhancing the uplink coverage.

In one implementation, the first other information is the indication information of the bandwidth part (BWP) or the code point corresponding to the BWP; and/or, the first other information is the indication information of the demodulation reference signal (DMRS) port or the code point corresponding to the DMRS port.

The present disclosure can explicitly or implicitly indicate the uplink transmission waveform used by the terminal for PUSCH transmission through the BWP or the DMRS port, enabling the DCI for data scheduling to use the indication field corresponding to other information to carry the waveform indication information, furthermore, the second DCI may perform scheduling based on the same uplink transmission waveform, thereby reducing the overhead of the second DCI and enhancing the uplink coverage.

In one implementation, the first DCI is DCI without data scheduling, and the waveform indication information is carried in the second newly added information indication field and/or the second redefined information indication field in the first DCI.

The present disclosure uses the DCI without data scheduling to carry the waveform indication information to indicate the uplink transmission waveform used by the terminal for PUSCH transmission, so that the second DCI may perform scheduling based on the same uplink transmission waveform, thereby reducing the overhead of the second DCI and enhancing the uplink coverage.

In one implementation, the second newly added information indication field is an information indication field newly added in the DCI without data scheduling and used to indicate the uplink transmission waveform used by the terminal for PUSCH transmission.

The present disclosure newly adds an information indication field in the DCI for data scheduling to indicate the uplink transmission waveform used by the terminal for PUSCH transmission, enabling the DCI for data scheduling to carry the waveform indication information to indicate the uplink transmission waveform used by the terminal for PUSCH transmission, furthermore, the second DCI may perform scheduling based on the same uplink transmission waveform, thereby reducing the overhead of the second DCI and enhancing the uplink coverage.

In one implementation, the second redefined information indication field is used to jointly indicate the uplink transmission waveform used by the terminal for PUSCH transmission; the second redefined information indication field is also used to indicate the second other information, there is a predefined explicit or implicit correspondence between the second other information and the uplink transmission waveform, and the second other information is information other than the information indicating the uplink transmission waveform.

The present disclosure jointly indicates the uplink transmission waveform used by the terminal for PUSCH transmission through the existing indication field in the DCI for data scheduling, enabling the DCI for data scheduling to carry the waveform indication information, furthermore, the second DCI may perform scheduling based on the same uplink transmission waveform, thereby reducing the overhead of the second DCI and enhancing the uplink coverage.

In one implementation, the second redefined information indication field is the indication field corresponding to the second other information.

The present disclosure can indicate the uplink transmission waveform used by the terminal for PUSCH transmission through the indication information contained in the indication field of the second other information or the code point, enabling the DCI for data scheduling to carry the waveform indication information, furthermore, the second DCI may perform scheduling based on the same uplink transmission waveform, thereby reducing the overhead of the second DCI and enhancing the uplink coverage.

In one implementation, the second other information is the DMRS sequence initialization information or the code point corresponding to the DMRS sequence initialization information; and/or, the second other information is the time domain resource allocation (TDRA) indication information or the code point corresponding to the TDRA.

The present disclosure can explicitly or implicitly indicate the uplink transmission waveform used by the terminal for PUSCH transmission through the DMRS sequence initialization information or the TDRA, enabling the DCI for data scheduling to use the indication field corresponding to the second other information to carry the waveform indication information, furthermore, the second DCI may perform scheduling based on the same uplink transmission waveform, thereby reducing the overhead of the second DCI and enhancing the uplink coverage.

In one implementation, the first DCI is a group common (GC) DCI, and the waveform indication information is carried in the GC DCI.

The present disclosure uses the GC DCI to carry the waveform indication information to indicate the uplink transmission waveform used by the terminal for PUSCH transmission, so that the second DCI may perform scheduling based on the same uplink transmission waveform, thereby reducing the overhead of the second DCI and enhancing the uplink coverage.

In one implementation, the GC DCI is the group control indication information used to carry the uplink transmission waveform used by the terminal for PUSCH transmission.

The present disclosure constructs a GC DCI used to carry the uplink transmission waveform used by the terminal for PUSCH transmission, so that the second DCI may perform scheduling based on the same uplink transmission waveform, thereby reducing the overhead of the second DCI and enhancing the uplink coverage.

In one implementation, the GC DCI includes a third newly added information indication field that is newly added and used to indicate the uplink transmission waveform used by the terminal for PUSCH transmission; the GC DCI is also used to jointly indicate or respectively indicate the corresponding waveform indication information for a plurality of terminals within a specific group.

The present disclosure newly adds an information indication field in the GC DCI to indicate the uplink transmission waveform used by the terminal for PUSCH transmission, enabling the GC DCI to carry the waveform indication information to indicate the uplink transmission waveform used by the terminal for PUSCH transmission, furthermore, the second DCI may perform scheduling based on the same uplink transmission waveform, thereby reducing the overhead of the second DCI and enhancing the uplink coverage.

In one implementation, the GC DCI includes a third redefined information indication field used to jointly indicate the uplink transmission waveform used by the terminal for PUSCH transmission; the third redefined information indication field is also used to indicate the third other information, there is a predefined explicit or implicit correspondence between the third other information and the uplink transmission waveform, and the third other information is information other than the information indicating the uplink transmission waveform.

The present disclosure jointly indicates the uplink transmission waveform used by the terminal for PUSCH transmission through the existing indication field in the GC DCI, enabling the GC DCI to carry the waveform indication information, furthermore, the second DCI may perform scheduling based on the same uplink transmission waveform, thereby reducing the overhead of the second DCI and enhancing the uplink coverage.

In one implementation, the PUSCH includes at least one of the following: PUSCH of configured grant type 1; PUSCH of configured grant type 2; dynamic grant (DG) PUSCH.

The present disclosure can be applied to different types of PUSCH scenarios, so that in the case of different PUSCH configurations, by sending the first DCI to indicate the uplink transmission waveform used by the terminal for PUSCH transmission, the second DCI may perform scheduling based on the same uplink transmission waveform, thereby reducing the overhead of the second DCI and enhancing the uplink coverage.

In one implementation, the first DCI includes DCI 0_1, DCI 0_2, DCI 1_1 and/or DCI 1_2.

The present disclosure can be applied to scenarios of different types of DCI, so that in scenarios of different types of DCI, by sending the first DCI to indicate the uplink transmission waveform used by the terminal for PUSCH transmission, the second DCI may perform scheduling based on the same uplink transmission waveform, thereby reducing the overhead of the second DCI and enhancing the uplink coverage.

FIG. 11 is a schematic diagram of another configuration apparatus of uplink waveform according to an exemplary embodiment. Referring to FIG. 11, the apparatus 300 is configured in a terminal and includes: a receiving module 301, configured to receive the first downlink control information (DCI), where the first DCI includes waveform indication information, and the waveform indication information is used to indicate the uplink transmission waveform used by the terminal for the physical uplink shared channel (PUSCH) transmission; the receiving module 301 is further configured to receive the second DCI, where the second DCI performs scheduling using the uplink transmission waveform indicated by the waveform indication information.

The present disclosure indicates the uplink transmission waveform used by the terminal for PUSCH transmission by receiving the first DCI, so that the second DCI may perform scheduling based on the same uplink transmission waveform, thereby reducing the overhead of the second DCI and enhancing the uplink coverage.

In one implementation, the first DCI is DCI for data scheduling, and the waveform indication information is carried in the first newly added information indication field and/or the first redefined information indication field in the first DCI.

The present disclosure uses the DCI for data scheduling to carry the waveform indication information to indicate the uplink transmission waveform used by the terminal for PUSCH transmission, so that the second DCI may perform scheduling based on the same uplink transmission waveform, thereby reducing the overhead of the second DCI and enhancing the uplink coverage.

In one implementation, the first newly added information indication field is an information indication field newly added in the DCI for data scheduling and used to indicate the uplink transmission waveform used by the terminal for PUSCH transmission.

The present disclosure newly adds an information indication field in the DCI for data scheduling to indicate the uplink transmission waveform used by the terminal for PUSCH transmission, enabling the DCI for data scheduling to carry the waveform indication information to indicate the uplink transmission waveform used by the terminal for PUSCH transmission, furthermore, the second DCI may perform scheduling based on the same uplink transmission waveform, thereby reducing the overhead of the second DCI and enhancing the uplink coverage.

In one implementation, the first redefined information indication field is used to jointly indicate the uplink transmission waveform used by the terminal for PUSCH transmission; the first redefined information indication field is also used to indicate the first other information, there is a predefined explicit or implicit correspondence between the first other information and the uplink transmission waveform, and the first other information is information other than the information indicating the uplink transmission waveform.

The present disclosure jointly indicates the uplink transmission waveform used by the terminal for PUSCH transmission through the existing indication field in the DCI for data scheduling, enabling the DCI for data scheduling to carry the waveform indication information, furthermore, the second DCI may perform scheduling based on the same uplink transmission waveform, thereby reducing the overhead of the second DCI and enhancing the uplink coverage.

In one implementation, the first redefined information indication field is the indication field corresponding to the first other information.

The present disclosure can indicate the uplink transmission waveform used by the terminal for PUSCH transmission through the code point or the indication information contained in the indication field of other information, enabling the DCI for data scheduling to carry the waveform indication information, furthermore, the second DCI may perform scheduling based on the same uplink transmission waveform, thereby reducing the overhead of the second DCI and enhancing the uplink coverage.

In one implementation, the first other information is the indication information of the bandwidth part (BWP) or the code point corresponding to the BWP; and/or, the first other information is the indication information of the demodulation reference signal (DMRS) port or the code point corresponding to the DMRS port.

The present disclosure can explicitly or implicitly indicate the uplink transmission waveform used by the terminal for PUSCH transmission through the BWP or the DMRS port, enabling the DCI for data scheduling to use the indication field corresponding to other information to carry the waveform indication information, furthermore, the second DCI may perform scheduling based on the same uplink transmission waveform, thereby reducing the overhead of the second DCI and enhancing the uplink coverage.

In one implementation, the first DCI is DCI without data scheduling, and the waveform indication information is carried in the second newly added information indication field and/or the second redefined information indication field in the first DCI.

The present disclosure uses the DCI without data scheduling to carry the waveform indication information to indicate the uplink transmission waveform used by the terminal for PUSCH transmission, so that the second DCI may perform scheduling based on the same uplink transmission waveform, thereby reducing the overhead of the second DCI and enhancing the uplink coverage.

In one implementation, the second newly added information indication field is an information indication field newly added in the DCI without data scheduling and used to indicate the uplink transmission waveform used by the terminal for PUSCH transmission.

The present disclosure newly adds an information indication field in the DCI for data scheduling to indicate the uplink transmission waveform used by the terminal for PUSCH transmission, enabling the DCI for data scheduling to carry the waveform indication information to indicate the uplink transmission waveform used by the terminal for PUSCH transmission, furthermore, the second DCI may perform scheduling based on the same uplink transmission waveform, thereby reducing the overhead of the second DCI and enhancing the uplink coverage.

In one implementation, the second redefined information indication field is used to jointly indicate the uplink transmission waveform used by the terminal for PUSCH transmission; the second redefined information indication field is also used to indicate the second other information, there is a predefined explicit or implicit correspondence between the second other information and the uplink transmission waveform, and the second other information is information other than the information indicating the uplink transmission waveform.

The present disclosure jointly indicates the uplink transmission waveform used by the terminal for PUSCH transmission through the existing indication field in the DCI for data scheduling, enabling the DCI for data scheduling to carry the waveform indication information, furthermore, the second DCI may perform scheduling based on the same uplink transmission waveform, thereby reducing the overhead of the second DCI and enhancing the uplink coverage.

In one implementation, the second redefined information indication field is the indication field corresponding to the second other information.

The present disclosure can indicate the uplink transmission waveform used by the terminal for PUSCH transmission through the indication information or code point contained in the indication field of the second other information, enabling the DCI for data scheduling to carry the waveform indication information, furthermore, the second DCI may perform scheduling based on the same uplink transmission waveform, thereby reducing the overhead of the second DCI and enhancing the uplink coverage.

In one implementation, the second other information is the DMRS sequence initialization information or the code point corresponding to the DMRS sequence initialization information; and/or, the second other information is the time domain resource allocation (TDRA) indication information or the code point corresponding to the TDRA.

The present disclosure can explicitly or implicitly indicate the uplink transmission waveform used by the terminal for PUSCH transmission through the DMRS sequence initialization information or the TDRA, enabling the DCI for data scheduling to use the indication field corresponding to the second other information to carry the waveform indication information, furthermore, the second DCI may perform scheduling based on the same uplink transmission waveform, thereby reducing the overhead of the second DCI and enhancing the uplink coverage.

In one implementation, the first DCI is a group common (GC) DCI, and the waveform indication information is carried in the GC DCI.

The present disclosure uses the GC DCI to carry the waveform indication information to indicate the uplink transmission waveform used by the terminal for PUSCH transmission, so that the second DCI may perform scheduling based on the same uplink transmission waveform, thereby reducing the overhead of the second DCI and enhancing the uplink coverage.

In one implementation, the GC DCI is the group common control indication information used to carry the uplink transmission waveform used by the terminal for PUSCH transmission.

The present disclosure constructs a GC DCI used to carry the uplink transmission waveform used by the terminal for PUSCH transmission, so that the second DCI may perform scheduling based on the same uplink transmission waveform, thereby reducing the overhead of the second DCI and enhancing the uplink coverage.

In one implementation, the GC DCI includes a third newly added information indication field that is newly added and dedicated to indicate the uplink transmission waveform used by the terminal for PUSCH transmission; the GC DCI is also used to jointly indicate or respectively indicate the corresponding waveform indication information for a plurality of terminals within a specific group.

The present disclosure newly adds an information indication field in the GC DCI to indicate the uplink transmission waveform used by the terminal for PUSCH transmission, enabling the GC DCI to carry the waveform indication information to indicate the uplink transmission waveform used by the terminal for PUSCH transmission, furthermore, the second DCI may perform scheduling based on the same uplink transmission waveform, thereby reducing the overhead of the second DCI and enhancing the uplink coverage.

In one implementation, the GC DCI includes a third redefined information indication field used to jointly indicate the uplink transmission waveform used by the terminal for PUSCH transmission; the third redefined information indication field is also used to indicate the third other information, there is a predefined explicit or implicit correspondence between the third other information and the uplink transmission waveform, and the third other information is information other than the information indicating the uplink transmission waveform.

The present disclosure jointly indicates the uplink transmission waveform used by the terminal for PUSCH transmission through the existing indication field in the GC DCI, enabling the GC DCI to carry the waveform indication information, furthermore, the second DCI may perform scheduling based on the same uplink transmission waveform, thereby reducing the overhead of the second DCI and enhancing the uplink coverage.

In one implementation, the PUSCH includes at least one of the following: PUSCH of configured grant type 1; PUSCH of configured grant type 2; dynamic grant (DG) PUSCH.

The present disclosure can be applied to different types of PUSCH scenarios, so that in the case of different PUSCH configurations, by receiving the first DCI to indicate the uplink transmission waveform used by the terminal for PUSCH transmission, the second DCI may perform scheduling based on the same uplink transmission waveform, thereby reducing the overhead of the second DCI and enhancing the uplink coverage.

In one implementation, the first DCI includes DCI 0_1, DCI 0_2, DCI 1_1 and/or DCI 1_2.

The present disclosure can be applied to scenarios of different types of DCI, so that in scenarios of different types of DCI, by receiving the first DCI to indicate the uplink transmission waveform used by the terminal for PUSCH transmission, the second DCI may perform scheduling based on the same uplink transmission waveform, thereby reducing the overhead of the second DCI and enhancing the uplink coverage.

It should be noted that the various modules/units involved in the configuration apparatus 200 for the uplink waveform and the configuration apparatus 300 for the uplink waveform in the embodiments of the present disclosure are only for illustrative purposes and are not restrictive. For example, the configuration apparatus 200 for the uplink waveform in the embodiments of the present disclosure may further includes a receiving module and/or a processing module. The configuration apparatus 300 for the uplink waveform may further includes a sending module and/or a processing module. The various modules included in the configuration apparatus 200 for the uplink waveform and the configuration apparatus 300 for the uplink waveform may interact with each other, and may also interact with other network device(s).

Regarding the apparatus in the above embodiments, the specific manners in which individual modules perform operations have already been described in detail in the embodiments related to the method, and will not be elaborated here.

FIG. 12 is a schematic diagram of a configuration device of uplink waveform according to an exemplary embodiment. For example, the device 400 may be provided as a base station or a server. Referring to FIG. 12, the device 400 includes a processing component 422, which further includes one or more processors, and a memory resource represented by the memory 432, used to store instructions that can be executed by the processing component 422, such as application. The application stored in the memory 432 may include one or more modules, each corresponding to a set of instructions. In addition, the processing component 422 is configured to execute instructions to perform the above methods.

The device 400 may further includes a power component 426 configured to perform the power management of the device 400, a wired or wireless network interface 450 configured to connect the device 400 to a network, and an input/output (I/O) interface 458. The device 400 may operate based on the operating system stored in the memory 432, such as Windows Server™, Mac OS X™, Unix™, Linux™, FreeBSD™ or the like.

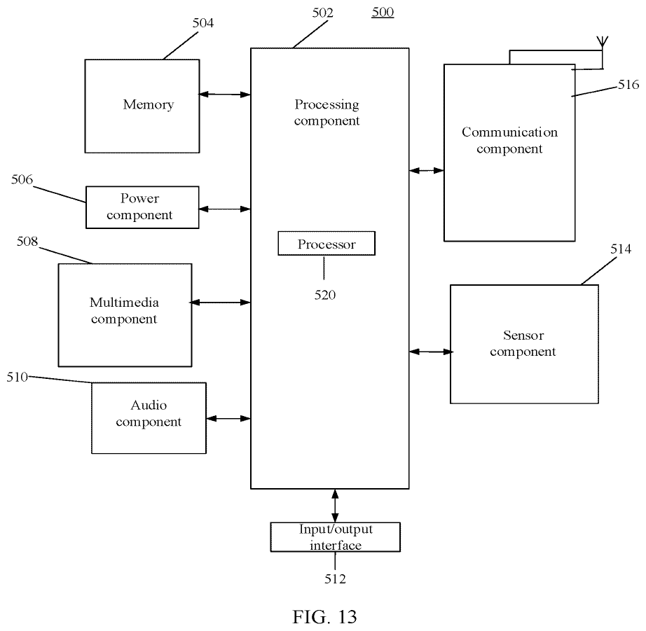

FIG. 13 is a schematic diagram of another configuration device of uplink waveform according to an exemplary embodiment. For example, the device 500 may be a mobile phone, a computer, a digital broadcast terminal, a messaging device, a game console, a tablet device, a medical device, a fitness device, a personal digital assistant, etc.

Referring to FIG. 13, the device 500 may include one or more of the following components: a processing component 502, a memory 504, a power component 506, a multimedia component 508, an audio component 510, an input/output (I/O) interface 512, a sensor component 514, and a communication component 516.

The processing component 502 typically controls the overall operation of the device 500, such as operations associated with display, phone calls, data communication, camera operations, and recording operations. The processing component 502 may include one or more processors 520 to execute instructions to complete all or part of the steps of the above methods. In addition, the processing component 502 may include one or more modules to facilitate the interaction between the processing component 502 and other components. For example, the processing component 502 may include a multimedia module to facilitate the interaction between the multimedia component 508 and the processing component 502.

The memory 504 is configured to store various types of data to support the operation of the device 500. Examples of such data include instructions for any application program or method operating on the device 500, contact data, phone book data, messages, pictures, videos, etc. The memory 504 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

The power component 506 supplies power to various components of the device 500. The power component 506 may include a power management system, one or more power supplies, and other components associated with generating, managing, and distributing power for the device 500.

The multimedia component 508 includes a screen that provides an output interface between the device 500 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense the boundaries of touch or swipe actions, but also detect the duration and pressure associated with the touch or swipe operation. In some embodiments, the multimedia component 508 includes a front camera and/or a rear camera. When the device 500 is in an operating mode, such as a shooting mode or a video mode, the front camera and/or the rear camera may receive external multimedia data. Each front camera and rear camera may be a fixed optical lens system or have focus and optical zoom capability.

The audio component 510 is configured to output and/or input audio signals. For example, the audio component 510 includes a microphone (MIC). When the device 500 is in an operating mode, such as a call mode, a recording mode, and a voice recognition mode, the microphone is configured to receive external audio signals. The received audio signals may be further stored in the memory 504 or sent via the communication component 516. In some embodiments, the audio component 510 further includes a speaker for outputting audio signals.

The I/O interface 512 provides an interface between the processing component 502 and peripheral interface modules, and the above peripheral interface modules may be a keyboard, a click wheel, buttons, etc. These buttons may include but are not limited to: a home button, a volume button, a starting button, and a locking button.

The sensor component 514 includes one or more sensors for providing a status assessment of various aspects of the device 500. For example, the sensor component 514 may detect the on/off status of the device 500, the relative positioning of components, such as the display and keypad of the device 500. The sensor component 514 may also detect the position change of the device 500 or a component of the device 500, the presence or absence of user contact with the device 500, the orientation or acceleration/deceleration of the device 500, and the temperature change of the device 500. The sensor component 514 may include a proximity sensor configured to detect the presence of nearby objects without any physical contact. The sensor component 514 may further include an optical sensor, such as a CMOS or CCD image sensor, for use in imaging applications. In some embodiments, the sensor component 514 may further include an acceleration sensor, a gyroscope sensor, a magnetic sensor, a pressure sensor, or a temperature sensor.

The communication component 516 is configured to facilitate wired or wireless communication between the device 500 and other devices. The device 500 may access a wireless network based on communication standards, such as WiFi, 2G or 3G, or a combination thereof. In an exemplary embodiment, the communication component 516 receives broadcast signals or broadcast-related information from an external broadcast management system via a broadcast channel. In an exemplary embodiment, the communication component 516 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an exemplary embodiment, the device 500 may be implemented by one or more application-specific integrated circuits (ASIC), digital signal processors (DSP), digital signal processing devices (DSPD), programmable logic devices (PLD), field programmable gate arrays (FPGA), controllers, microcontrollers, microprocessors, or other electronic components, for performing the above methods.

In an exemplary embodiment, a non-transitory computer-readable storage medium including instructions is also provided, such as the memory 504 including instructions, and the above instructions may be executed by the processor 520 of the device 500 to complete the above method. For example, the non-transitory computer-readable storage medium may be a ROM, a random access memory (RAM), a CD-ROM, a magnetic tape, a floppy disk, and an optical data storage device, etc.

The present disclosure provides a base station configuration method that supports the dynamic switching of uplink waveform. The overhead of DCI corresponding to the solution is reduced, and it may be used to enhance the uplink coverage. It supports more flexible uplink waveform switching, which is used to support more dynamic waveform switching for users at the cell edge and obtain better performance.

It can be further understood that in the present disclosure, “a plurality of” refers to two or more, and other quantifiers are similar. “And/or” describes the association of associated objects, indicating that there may be three relationships, for example, “A and/or B” may mean: A exists alone, both A and B exist, and B exists alone. The character “/” generally indicates that the associated objects before and after are in an “or” relationship. Singular forms such as “a/an,” “said,” or “the” are intended to include plural forms unless the context clearly dictates otherwise.

It can be further understood that terms such as “first” and “second” are used to describe various information, but this information should not be limited to these terms. These terms are only used to distinguish information of the same type from each other, and do not indicate a specific order or degree of importance. In fact, expressions such as “first” and “second” may be used interchangeably. For example, without departing from the scope of the present disclosure, the first information may also be referred to as the second information, and similarly, the second information may also be referred to as the first information.

It can be further understood that although the operations are described in a specific order in the drawings in the embodiments of the present disclosure, it should not be construed as requiring the operations to be performed in the specific order shown or in a sequential order, or requiring all the operations shown to be performed to obtain the desired result. In certain scenarios, multitasking and parallel processing may be advantageous.

Those skilled in the art will readily conceive of other implementation solutions of the present disclosure after considering the specification and practicing the content disclosed herein. This application is intended to cover any variations, uses, or adaptations of the present disclosure that follow the general principles of the present disclosure and include common general knowledge or conventional technical means in the technical field not disclosed in the present disclosure.

It should be understood that the present disclosure is not limited to the precise structures described above and illustrated in the accompanying drawings, and various modifications and changes may be made without departing from its scope. The scope of the present disclosure is limited solely by the scope of the appended claims.

1. A configuration method of an uplink waveform, wherein the method is performed by a network device, and comprises:
sending first downlink control information (DCI), wherein the first DCI comprises waveform indication information, and the waveform indication information is used to indicate an uplink transmission waveform used by a terminal for a physical uplink shared channel (PUSCH) transmission; and
sending second DCI, wherein the second DCI performs scheduling using the uplink transmission waveform indicated by the waveform indication information.

2. The method according to claim 1, wherein the first DCI is DCI for data scheduling, and the waveform indication information is carried in at least one of a first newly added information indication field or a first redefined information indication field in the first DCI.

3. The method according to claim 2, wherein the first newly added information indication field is an information indication field newly added in the DCI for data scheduling and used to indicate the uplink transmission waveform used by the terminal for the PUSCH transmission.

4. The method according to claim 2, wherein the first redefined information indication field is used to jointly indicate the uplink transmission waveform used by the terminal for the PUSCH transmission,
the first redefined information indication field is further used to indicate first other information, a predefined explicit or implicit correspondence exists between the first other information and the uplink transmission waveform, and the first other information is information other than the information indicating the uplink transmission waveform,
the first redefined information indication field is an indication field corresponding to the first other information,
the first other information is indication information of a bandwidth part (BWP) or a code point corresponding to the BWP, and/or
the first other information is indication information of a demodulation reference signal (DMRS) port or a code point corresponding to the DMRS port.

5-6. (canceled)

7. The method according to claim 1, wherein the first DCI is DCI without data scheduling, and the waveform indication information is carried in at least one of a second newly added information indication field or a second redefined information indication field in the first DCI.

8. The method according to claim 7, wherein the second newly added information indication field is an information indication field newly added in the DCI without data scheduling and used to indicate the uplink transmission waveform used by the terminal for the PUSCH transmission.

9. The method according to claim 7, wherein the second redefined information indication field is used to jointly indicate the uplink transmission waveform used by the terminal for the PUSCH transmission,
the second redefined information indication field is further used to indicate second other information, a predefined explicit or implicit correspondence exists between the second other information and the uplink transmission waveform, and the second other information is information other than the information indicating the uplink transmission waveform,
the second redefined information indication field is an indication field corresponding to the second other information,
the second other information is DMRS sequence initialization information or a code point corresponding to the DMRS sequence initialization information, and/or
the second other information is time domain resource allocation (TDRA) indication information or a code point corresponding to the TDRA.

10-11. (canceled)

12. The method according to claim 1, wherein the first DCI is a group common (GC) DCI, and the waveform indication information is carried in the GC DCI.

13. The method according to claim 12, wherein the GC DCI is group common control indication information used to carry the uplink transmission waveform used by the terminal for the PUSCH transmission,
the GC DCI comprises a third newly added information indication field newly added and used to indicate the uplink transmission waveform used by the terminal for the PUSCH transmission,
the GC DCI is further used to jointly indicate or respectively indicate corresponding waveform indication information for a plurality of terminals within a specific group,
the GC DCI comprises a third redefined information indication field used to jointly indicate the uplink transmission waveform used by the terminal for the PUSCH transmission, and
the third redefined information indication field is further used to indicate third other information, a predefined explicit or implicit correspondence exists between the third other information and the uplink transmission waveform, and the third other information is information other than the information indicating the uplink transmission waveform.

14-17. (canceled)

18. A configuration method of an uplink waveform, wherein the method is performed by a terminal, and comprises:
receiving first downlink control information (DCI), wherein the first DCI comprises waveform indication information, and the waveform indication information is used to indicate an uplink transmission waveform used by the terminal for a physical uplink shared channel (PUSCH) transmission; and
receiving second DCI, wherein the second DCI performs scheduling using the uplink transmission waveform indicated by the waveform indication information.

19. The method according to claim 18, wherein the first DCI is DCI for data scheduling, and the waveform indication information is carried in at least one of a first newly added information indication field or a first redefined information indication field in the first DCI.

20. The method according to claim 19, wherein the first newly added information indication field is an information indication field newly added in the DCI for data scheduling and used to indicate the uplink transmission waveform used by the terminal for the PUSCH transmission.

21. The method according to claim 19, wherein the first redefined information indication field is used to jointly indicate the uplink transmission waveform used by the terminal for the PUSCH transmission,
the first redefined information indication field is further used to indicate first other information, a predefined explicit or implicit correspondence exists between the first other information and the uplink transmission waveform, and the first other information is information other than the information indicating the uplink transmission waveform,
the first redefined information indication field is an indication field corresponding to the first other information,
the first other information is indication information of a bandwidth part (BWP) or a code point corresponding to the BWP, and/or
the first other information is indication information of a demodulation reference signal (DMRS) port or a code point corresponding to the DMRS port.

22-23. (canceled)

24. The method according to claim 18, wherein the first DCI is DCI without data scheduling, and the waveform indication information is carried in at least one of a second newly added information indication field or a second redefined information indication field in the first DCI.

25. The method according to claim 24, wherein the second newly added information indication field is an information indication field newly added in the DCI without data scheduling and used to indicate the uplink transmission waveform used by the terminal for the PUSCH transmission.

26. The method according to claim 24, wherein the second redefined information indication field is used to jointly indicate the uplink transmission waveform used by the terminal for the PUSCH transmission,
the second redefined information indication field is further used to indicate second other information, a predefined explicit or implicit correspondence exists between the second other information and the uplink transmission waveform, and the second other information is information other than the information indicating the uplink transmission waveform,
the second redefined information indication field is an indication field corresponding to the second other information,
the second other information is DMRS sequence initialization information or a code point corresponding to the DMRS sequence initialization information, and/or
the second other information is time domain resource allocation (TDRA) indication information or a code point corresponding to the TDRA.

27-28. (canceled)

29. The method according to claim 18, wherein the first DCI is a group common (GC) DCI, and the waveform indication information is carried in the GC DCI.

30. The method according to claim 29, wherein the GC DCI is group common control indication information used to carry the uplink transmission waveform used by the terminal for the PUSCH transmission,
the GC DCI comprises a third newly added information indication field newly added and dedicated to indicate the uplink transmission waveform used by the terminal for the PUSCH transmission,
the GC DCI is further used to jointly indicate or respectively indicate corresponding waveform indication information for a plurality of terminals within a specific group,
the GC DCI comprises a third redefined information indication field used to jointly indicate the uplink transmission waveform used by the terminal for the PUSCH transmission, and
the third redefined information indication field is further used to indicate third other information, a predefined explicit or implicit correspondence exists between the third other information and the uplink transmission waveform, and the third other information is information other than the information indicating the uplink transmission waveform.

31-36. (canceled)

37. A network device, comprising:
a processor; and
a memory for storing instructions executable by the processor,
wherein the processor is configured to:
send first downlink control information (DCI), wherein the first DCI comprises waveform indication information, and the waveform indication information is used to indicate an uplink transmission waveform used by a terminal for a physical uplink shared channel (PUSCH) transmission; and
send second DCI, wherein the second DCI performs scheduling using the uplink transmission waveform indicated by the waveform indication information.

38. A configuration device of an uplink waveform, comprising:
a processor; and
a memory for storing instructions executable by the processor,
wherein the processor is configured to execute the method according to claim 18.

39-40. (canceled)
